(19) United States
(12) Patent Application Publication
(10) Pub. No.: US 2009/0241365 A1
(43) Pub. Date: Oct. 1, 2009

(54) METHOD AND APPARATUS FOR DRYING

(75) Inventors: Takao TAGUCHI, Haibara-gun (JP); Kenji Hayashi, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/410,030

(22) Filed: Mar. 24, 2009

(30) Foreign Application Priority Data
Mar. 26, 2008 (JP) 2008-080390

(51) Int. Cl. F26B 7/00; F26B 25/20

(52) U.S. Cl. 34/389; 34/240

(57) ABSTRACT

A method for drying a material to be dried, the material containing a first solvent and being conveyed, comprising the steps of:
supplying hot air from a supply unit to the material, the hot air containing vapor of a second solvent having a smaller or equal molecular volume than the molecular volume of the first solvent,
wherein exhaust is discharged at farther upstream and farther downstream portions from windshield plates disposed at upstream and downstream of the supply unit, in the direction of conveying the material to be dried.

### BACKGROUND OF THE INVENTION

1. Field of the Invention

The present invention relates to a method and apparatus for drying, especially to a method and apparatus for drying employed in the manufacturing process of lithographic printing plates.

2. Description of the Related Art

Lithographic printing plate, various optical films, silver halide films, photographic papers, and magnetic recording materials such as base films for video tapes and the like are manufactured by applying coating liquids such as a photosensitive layer forming liquid, a thermosensitive layer forming liquid, a photosensitive emulsion, a magnetic layer forming liquid, and the like on belt-like materials such as a support web, a base film, baryta paper, and the like, the belt-like material being moved in one direction, followed by drying, and, if necessary, cutting into a predetermined size. In this manufacturing process, drying and removing solvents contained in the coating liquids with high accuracy is preferable in terms of product quality.

As a conventional drying method, one which uses dry hot air has been general, as is described in Japanese Patent Application Laid-Open No. 2004-205720. Also, various proposals have been made on drying methods whereby hot air containing solvent vapor is used. For example, Japanese Patent Application Laid-Open No. 2002-333275 proposes an apparatus whereby food is dried and processed using superheated steam.

However, the method of drying by hot air according to Japanese Patent Application Laid-Open No. 2004-205720 requires a long time and high-temperature hot air for drying because when the coating liquid solidifies to form a film, the residual solvent in the film becomes difficult to be removed. Thus, with this method, there is a possibility that quality deterioration and thermal decomposition of the film may be induced. Further, there is a problem that a huge drying zone becomes necessary.

Further, in the method of drying by a solvent vapor according to Japanese Patent Application Laid-Open No. 2002-333275, the temperature and amount (concentration) of the superheated steam to be used are not clearly defined. Also, condensation of steam on the surface of the material to be dried is not considered. If steam condenses on the surface of the material to be dried, it may become a cause to deteriorate the functions of materials to be dried, such as functional materials and the like. Also, efficiency of drying and removal of the solvent is not satisfactory.

Therefore, the present applicant has proposed, in WO 07/136005, a method whereby a high-boiling solvent is effectively dried and removed in an atmosphere containing a vapor of a low-boiling solvent. According to this method, the vapor of the second solvent absorbed in the film increases the free volume therein and a diffusion speed of the residual solvent (the first solvent and other residual solvents) increases, enabling the residual solvent to be removed rapidly and at a relatively low temperature. Further, the absorbed second solvent, having a smaller molecular volume than the residual solvent, can be easily removed by drying in dry air and, thus, the drying time as a whole can be shortened. Therefore, in a case of a drying system using the solvent vapor, the length of a drying box along the direction of conveying can be drastically shortened; for example, when the width of the drying box and length thereof in the conveying direction are denoted by W and L, respectively, a drying box having a shape corresponding to W/L≧1 can be used.

### SUMMARY OF THE INVENTION

However, when a drying box with a shape corresponding to W/L≧1 is used, there arises a problem that unevenness in drying becomes very easy to occur in a width direction of the web. To explain this phenomenon more specifically, the drying capacity of a drying system using a solvent vapor has a property that it is greatly affected by the concentration of the solvent vapor rather than the drying temperature. Further, the diffusion speed of the solvent vapor fluctuates more easily than the diffusion speed of heat. This can be understood from Lewis' Equation (namely, in a laminar film, when the film coefficients of heat transfer and mass transfer were denoted by h and k, respectively, there is a relationship that h/k=0.26, meaning that a fluctuation of Δh=1 corresponds to a fluctuation of Δk=3.8). Thus, the atmosphere inside a drying box having a shape corresponding to W/L≧1 is easier to become non-uniform than in the case of drying by a hot air. Therefore, when W/L≧1, uneven drying occurs because of non-uniform solvent vapor atmosphere occurred in the drying box and, thus the problem arises that uneven distribution of the residual solvent occurs in the width direction.

The present invention was made in view of such circumstances and an object of the present invention is to provide a method and an apparatus for drying, comprising a drying system using a solvent vapor whereby occurrence of non-uniform drying is suppressed.

In order to attain the aforementioned objective, the 1st aspect of the present invention provides a method for drying a material to be dried, the material containing a first solvent and being conveyed, comprising the steps of: supplying hot air from a supply unit to the material, the hot air containing vapor of a second solvent having a smaller or equal molecular volume than the molecular volume of the first solvent, wherein exhaust is discharged at farther upstream and farther downstream portions from windshield plates disposed at upstream and downstream of the supply unit, in the direction of conveying the material to be dried.

The inventor of the present invention conducted drying tests and flow simulations by numerical computing intensively and, as a result, found that vapor atmosphere of the second solvent becomes less susceptible to disturbance and the uneven distribution of the residual first solvent is greatly improved by installing exhaust outlets at the upstream and downstream sides of a supplying zone of vapor-containing hot air and further installing windshield plates between the two exhaust outlets and the supply unit. The present invention was completed based on these findings and, because exhaust discharge is carried out at farther sides of the windshield plates disposed at both ends of the supply zone of vapor-containing hot air, can greatly improve the uneven distribution of the residual first solvent and can prevent non-uniform drying.

In addition, when the material to be dried contains a plurality of solvents in the present invention, one with the largest molecular volume is regarded as the first solvent.

Further, in the present invention, it is preferable to supply hot air containing vapor of the second solvent after the material to be dried is dried to a drying point of a solution containing the first solvent.

The 2nd aspect of the present invention is an invention according to the 1st aspect, wherein the material to be dried is supported by a support roller from an opposite side of the supply unit.

The inventor of the present invention has found that, by supporting the material to be dried by a support roller from the opposite side of the vapor-containing hot air supply unit, the effect of improvement of the aforementioned uneven distribution of the residual first solvent becomes larger. This is thought to be due to installation of a support roller which removes warpage and loosening of the material to be dried and makes the clearance between the material to be dried and the member of the vapor-containing hot air supply unit uniform in the width direction, thus making the wind velocity of the vapor-containing hot air on the surface of the material to be dried homogeneous along the width direction. The present invention was made based on these findings. Installation of the support roller makes it possible to more reliably prevent uneven drying.

The 3rd aspect of the present invention is an invention according to 1st aspect or 2nd aspect, wherein, when the distance between the windshield plates and width of the vapor-containing hot air supply unit are denoted by L and W, respectively, a relationship W/L≧1 is satisfied.

Even though there is a problem that uneven distribution of the residual first solvent is especially likely to occur when the hot air containing the vapor of the second solvent is used in a drying box with a shape corresponding to W/L≧1, application of the present invention can prevent this problem. Namely, by applying the present invention, uniform drying can be attained even under a condition of W/L≧1, in contrast to the conventional drying method whereby uniform drying is accomplished under a drying condition of W/L<1, but there was a problem of uneven drying occurring under a drying condition of W/L≧1.

The 4th aspect of the present invention is an invention according to any one of aspects 1 to 3, wherein the ratio of the amount of vapor of the second solvent is 0.2 or more but 1.0 or less to the saturated vapor amount of the second solvent at the boiling point under ordinary pressure. This is because, when the ratio is less than 0.2, performance of vapor drying by the second solvent is not exhibited, and when the ratio exceeds 1.0, the pressure of the second solvent becomes higher than the ordinary pressure.

The 5th aspect of the present invention is an invention according to any one of aspects 1 to 4, wherein the temperature of hot air containing the vapor of the second solvent is not lower than the boiling point of the second solvent under ordinary pressure. This is because, when the temperature of the second solvent is lower than its boiling point, the vapor drying performance by the second solvent drops.

In order to attain the aforementioned object, the 6th aspect of the present invention is a drying apparatus equipped with a supply unit which supplies hot air containing vapor of a second solvent having a smaller or equal molecular volume than the molecular volume of a first solvent to a material to be dried, the material containing the first solvent and being conveyed, comprising exhaust outlets disposed at upstream and downstream of the supply unit in relation to the direction of conveying the material to be dried and windshield plates disposed between the exhaust outlets and the supply unit and with a predetermined gap from the material to be dried.

According to the present invention, exhaust outlets are disposed at upstream and downstream of the vapor-containing hot air supply unit and, at the same time, the windshield plates are installed between the exhaust outlets and the supply unit. Thus, discharge is carried out at farther upstream and farther downstream portions from the windshield plates disposed at upstream and downstream of the supply unit. Therefore, uneven distribution of the residual first solvent is greatly improved and non-uniform drying can be prevented.

The 7th aspect of the present invention is an invention according to the 6th aspect, wherein a support roller is installed at the opposite side of the material to be dried from the supply unit and the support roller is made to come in contact with the material to be dried.

According to the present invention, a support roller is installed and is made to come into contact with the material to be dried. Thus, the vapor containing hot air contacts the surface of the material to be dried with uniform wind velocity and makes improvement of the uneven distribution of the residual first solvent more effective.

The 8th aspect of the present invention is an invention according to aspect 6 or 7, wherein, when the distance between the windshield plates themselves and width of the supply unit are denoted by L and W, respectively, a relationship W/L≧1 is satisfied.

Even though there is a problem that uneven distribution of the residual first solvent is especially likely to occur when the condition of hot air containing the vapor of the second solvent is set at W/L≧1, application of the present invention can prevent this problem.

According to the present invention, exhaust discharge is carried out at farther upstream and downstream sides from the windshield plates disposed at upstream and downstream of the supply zone of vapor-containing hot air. Thus, uneven distribution of the residual first solvent can be greatly improved and non-uniform drying can be prevented.

### BRIEF DESCRIPTION OF THE DRAWINGS

FIG. 1 is a diagram illustrating a basic configuration of a manufacturing apparatus of a lithographic printing plate precursor according to the preset embodiment;

FIG. 2 is a diagram illustrating a configuration of a drying apparatus;

FIG. 3 is a diagram illustrating a vapor supply and dischrging system for a vapor drying section;

FIG. 4 is a diagram illustrating an internal configuration of a vapor atmosphere drying section according to the first embodiment;

FIG. 5 is a cross-sectional view along line 5-5 of FIG. 4;

FIG. 6 is a diagram illustrating a vapor atmosphere drying section of Comparative Examples;

FIG. 7 is a diagram illustrating an internal configuration of a vapor atmosphere drying section according to the second embodiment; and

FIG. 8 is a diagram illustrating an internal configuration of a vapor atmosphere drying section according to the third embodiment.

### DETAILED DESCRIPTION OF THE PREFERRED EMBODIMENTS

Hereinafter, the preferred embodiments of the method and apparatus for drying according to the present invention will be described referring to the accompanying drawings. Further, in the present embodiments, a drying apparatus for evaporating to dryness a difficult to evaporate solvent, contained in a coated film of an image-forming layer, will be described as an example in a manufacturing apparatus for lithographic printing plate precursors. However, the present invention is not limited to this technical field, and is applicable to methods and apparatuses for drying in various technical fields.

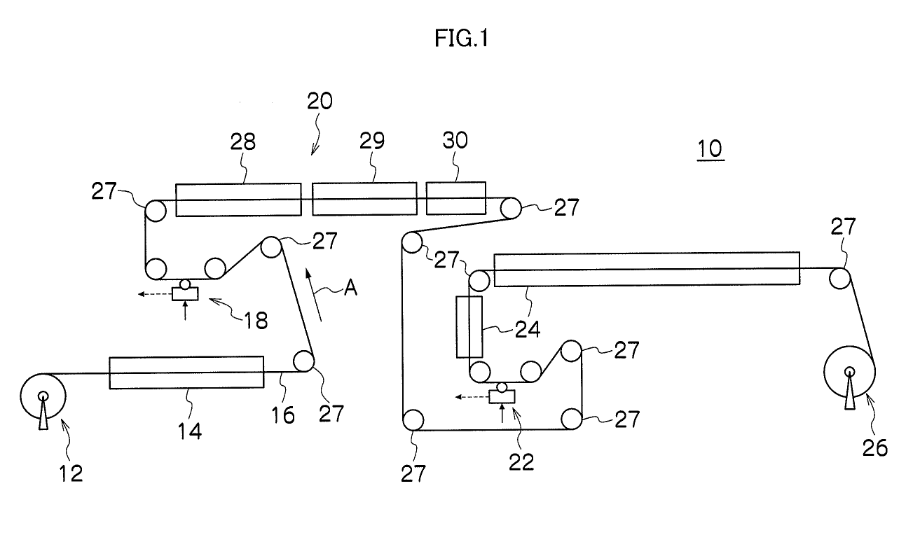

First, a basic configuration of the manufacturing apparatus 10 of lithographic printing plate precursors of the present embodiment will be described. FIG. 1 is a diagram showing a basic configuration of the manufacturing apparatus 10 of lithographic printing plate precursors according to the present embodiment, where an arrow A indicates the conveying direction of a support 16.

As is shown in FIG. 1, the manufacturing apparatus 10 of the lithographic printing plate precursors mainly comprises a delivery apparatus 12, a surface treatment apparatus 14, a coating apparatus 18, a drying apparatus 20, a coating apparatus 22, a drying apparatus 24, and a take-up apparatus 26. From the delivery apparatus 12, the support 16 is delivered, guided by a guide roller 27, and conveyed to each process.

The support 16 is first subjected to a coating surface treatment in the surface treatment apparatus 14 and, after a coating liquid for image-forming layer is coated on the coating surface by the coating apparatus 18, the image recording layer is dried in the drying apparatus 20. Further, the support 16 is coated with an overcoat layer on the image forming layer in the coating apparatus 22 and, after this overcoat layer is dried in the drying apparatus 24, it is wound up by the take-up apparatus 26. In addition, the configuration shown in FIG. 1 is only an example of the manufacturing apparatuses of lithographic printing plates and the present invention is not limited to this. For example, there may be installed a coating apparatus for coating a base coating liquid before coating the coating liquid for the image-forming layer or a humidity control apparatus may be disposed after the drying apparatus 24 for the overcoat layer to control the moisture of the overcoat layer.

Next, each process will be described.

The surface treatment apparatus 14 is an apparatus for providing various necessary pretreatments to the support 16 before coating. The pretreatments include a degreasing treatment and a surface roughening treatment (sandblasting and the like) which improve adhesion between the support 16 and an image-forming layer, and impart water retentivity to the non-image region; an anodizing treatment whereby an oxide layer is formed on the surface in order to improve abrasion resistance, chemical resistance, and water retentivity of the support 16; a silicate treatment which improves the film strength and hydrophilicity of the anodized film, and adhesion thereof with the image-forming layer; and the like.

The coating apparatus 18 is an apparatus for coating the coating liquid for image-forming layer on the surface of the support 16. The coating methods include, for example, a slide bead coating method, a curtain coating method, a bar coating method, a spin coating method, a spray coating method, a dip coating method, an air knife coating method, a blade coating method, and a roll coating method. Among these, the slide bead coating method, curtain coating method, and bar coating method are preferably used. In addition, the coating method illustrated in FIG. 1 is a bar coating method.

The drying apparatus 20 is an apparatus for drying the image-forming layer provided on the support 16. The coated film of the image-forming layer to be dried contains as the first solvent a difficult to evaporate, high boiling point solvent. It is important for the quality of the lithographic printing plate precursors to evaporate this first solvent effectively to dryness in the drying apparatus 20. The configuration of the drying apparatus 20 will be described in detail later but comprises a hot air drying section 28, a vapor atmosphere drying section 29, and a cooling section 30. These hot air drying section 28, vapor atmosphere drying section 29, and cooling section 30 are each box-shaped and are configured in such a way that the support 16 can pass through the inside thereof. The support 16 is first blown by hot air in the hot air drying section 28 and then blown by hot air containing vapor of the second solvent in the vapor atmosphere drying section 29. Thereafter, a cold wind is blown thereon in the cooling section 30 and the support is cooled.

The coating apparatus 22 is an apparatus which forms a water-soluble overcoat layer on the image-forming layer in order to shut off oxygen from the image-forming layer and to prevent contamination of the surface thereof by lipophilic substances. The water-soluble overcoat layer can be removed easily at the time of printing and comprises a resin selected from water-soluble organic polymeric compounds. As the method of coating the water-soluble overcoat layer, an apparatus similar to the coating apparatus 18 mentioned above may be used. The support 16 coated with the water-soluble overcoat layer is dried in the drying apparatus 24 and finally wound up by the take-up apparatus 26.

In the following, the drying apparatus 20 according to the present invention will be described.

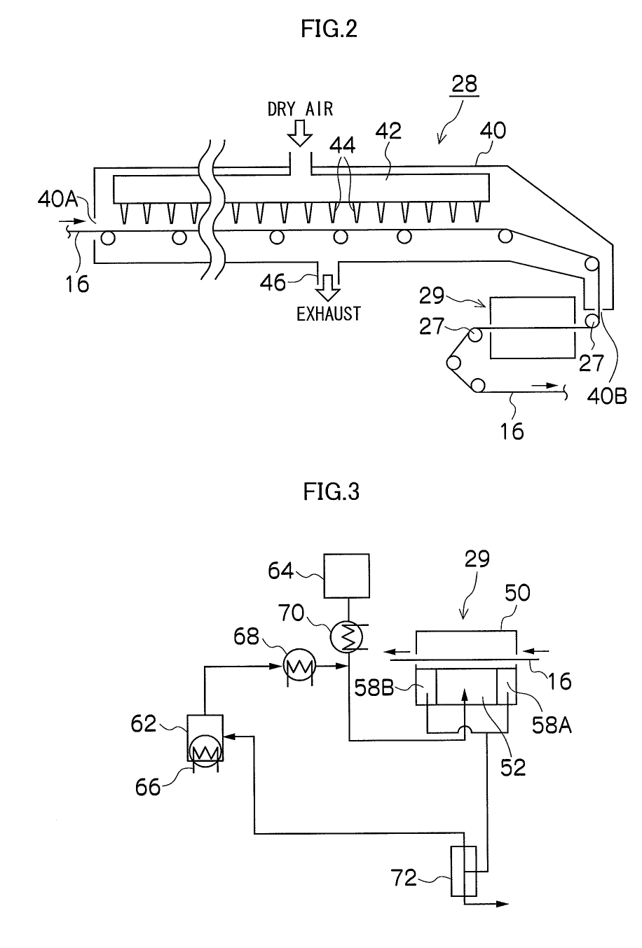

As illustrated in FIG. 2, the hot air drying section 28 of the drying apparatus 20 comprises a box 40 formed along the conveying direction of the support 16. The box 40 comprises slit-like openings 40A and 40B at both ends, through which the support 16 enters and leaves the box 40.

Inside the box 40, a chamber 42 is installed above the support 16 and to this chamber 42 is supplied high-temperature dry air (hot air). On the lower surface of the chamber 42, there are provided a number of nozzles 44. Through these nozzles 44, hot air is blown onto the upper surface (namely, the image forming layer) of the support 16.

On the bottom of the box 40, an exhaust outlet 46 is disposed. By carrying out exhaust discharge through this exhaust outlet 46, a downflow of hot air is formed inside the box 40.

In this hot air drying section 28, drying is carried out to a drying point (a state where the coating liquid does not stick when touched with a cloth, a state where the surface glossiness does not change, or a state where the solid content is 60% or higher, preferably 70% to 80%). The dried support 16 is guided by a guide roller 27, turned upside down, and delivered to the vapor atmosphere drying section 29.

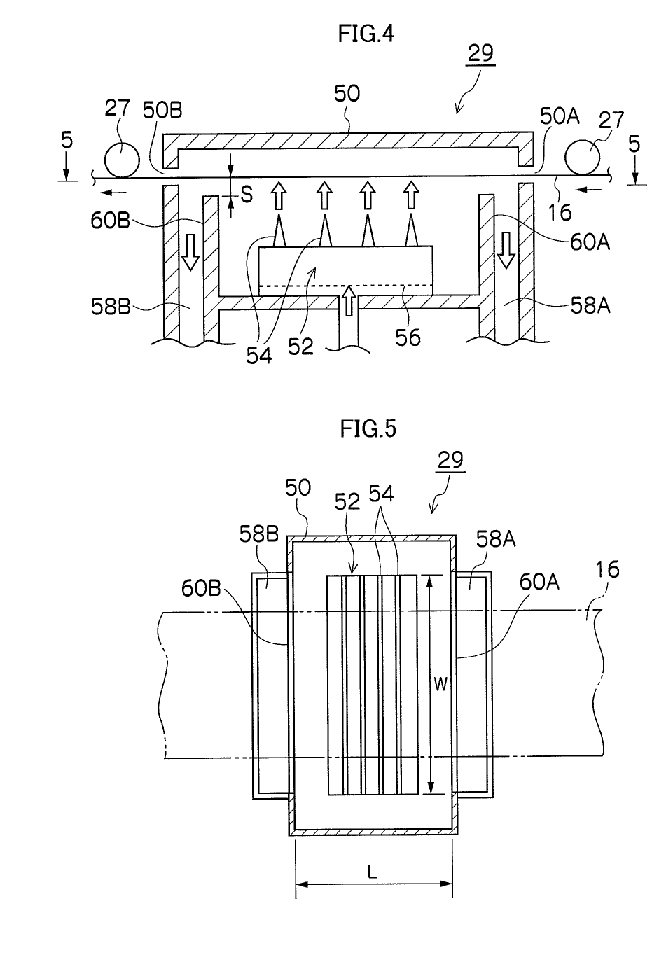

FIG. 3 illustrates a vapor supply and ventilation system which supply a vapor to and ventilate an exhaust gas from the vapor atmosphere drying section 29. Further, FIG. 4 shows an internal configuration of the vapor atmosphere drying section 29. FIG. 5 is a cross-sectional view taken along the line 5-5 of FIG. 4.

The vapor atmosphere drying section 29 shown in these figures is an apparatus which evaporates to dryness the first solvent contained in the film coated on the support 16. Preferably, the first solvent to be dried is a high boiling point solvent, more preferably one with a boiling point of 150° C. or higher. Examples of this first solvent include γ-butyrolactone (204° C.), acetamide (222° C.), 1,3-dimethyl-2-imidazolidinone (225.5° C.), N,N-dimethylformamide (153° C.), tetramethyl urea (175° C.-177° C.), nitrobenzene (211.3° C.), formamide (210.5° C.), N-methylpyrrolidone (202° C.), N,N-dimethylacetamide (166° C.), dimethyl sulfoxide (189° C.). Here, the numbers in parentheses are boiling points.

As is shown in FIG. 4, the vapor atmosphere drying section 29 comprises a hollow box 50 and on the opposite sides thereof facing each other, slit-like openings 50A and 50B are formed. The support 16 enters the box through the opening 50A and is conveyed out of the box 50 through the opening 50B. Preferably, the material of the box 50 is, for example, SUS (304, 306, 316, and the like) and iron (SESC, and the like). Inside the box, there may be provided a heat insulating material such as glass wool, rock wool, and ALK 24.

Inside the box 50, a supply unit 52 of the vapor-containing hot air is disposed below the support 16. The supply unit 52 is formed in a hollow box shape, wherein vapor-containing hot air is supplied by the vapor supply and ventilation system illustrated in FIG. 3.

The vapor supply and ventilation system comprises a tank 62, a blower 64, a heat exchangers 66, 68, and 70, where the tank 62 stores the second solvent. As the second solvent, a solvent having a molecular volume not larger than that of the aforementioned first solvent is used. This second solvent usually has a lower boiling point than the first solvent and is preferably a liquid at ordinary temperature (ca. 20° C.). Examples of the second solvent include water, methanol, acetone, and methyl ethyl ketone. When organic solvents are used as the second solvent, it is desired that the concentration used is controlled so as not to fall into the explosion range and that explosion protection measures are taken.

The second solvent stored in the tank 62 is heated by the heat exchanger 66 to become a vapor, which is, after temperature adjustment by the heat exchanger 68, mixed with air which is blown from the blower 64 and heated at the heat exchanger 70, and supplied to the supply unit 52.

As shown in FIG. 4, straightening vanes 56 are installed inside the supply unit 52 and, due to these straightening vanes 56, the vapor-containing hot air is uniformly supplied. On the upper side of the supply unit 52, there are disposed nozzles 54, through which the vapor-containing hot air is blown in the direction of the lower side (namely, the image-forming layer) of the support 16. The nozzles 54 are designed to blow the vapor-containing hot air uniformly to the support 16 along the width direction. For example, the nozzle comprises a slit in the width direction, through which the vapor-containing hot air is blown out. Also, there are installed a plurality of nozzles 54 in the conveying direction of the support 16. Thus, the vapor-containing hot air is blown onto the support 16 over a predetermined range in the conveying direction of the support 16. Further, as is illustrated in FIG. 5, the width, W, of the supply unit 52 is formed in a larger size than the width of the support 16, making it possible to blow the vapor-containing hot air all over the support 16 in the width direction. In addition, the width, W, of the supply unit 52 is preferably set larger than the length, L, of the zone (specifically, the distance between the windshield plates 60A and 60B as will be described later) where a vapor atmosphere of the second solvent is formed. The ratio, W/L, is preferably 1 or larger, more preferably 2 or larger. With larger value of W/L, L can be made smaller to downsize the apparatus, but uneven distribution of the residual first solvent in the width direction becomes easy to occur. When W/L is 1 or larger, the conventional method could not prevent occurrence of the distribution of the residual solvent but the present invention can prevent this, showing a particularly remarkable effect of the present invention.

From the nozzles 54 of the supply unit 52 configured as described above, the vapor-containing hot air is blown out and a vapor atmosphere of the second solvent is formed inside the box 50. Thus, drying of the first solvent contained in the film on the support 16 is carried out.

As shown in FIG. 4, the exhaust outlets 58A and 58B are disposed at upstream and downstream of the supply unit 52 relative to the conveying direction of support 16. These exhaust outlets 58A and 58B are provided below the support 16 as the supply unit 52 and suck air down from around the underside of support 16. As shown in FIG. 5, the exhaust outlets 58A and 58B are formed with wider width than support 16, preferably with the same width, W, as the supply unit 52. In addition, the exhaust outlets 58A and 58B are connected to the distillation column 72 as illustrated in FIG. 3, and the exhaust air from the exhaust outlets 58A and 58B is sent to the distillation column 72. From the exhaust air sent to distillation column 72, the second and first solvents are separated; the second solvent separated is returned to the tank 62 and the first solvent is recovered. In addition, the volume of air discharged from the exhaust outlets 58A and 58B is set to be larger than the volume of vapor-containing hot air blown out from the supply unit 52. Thus, leakage of the vapor-containing hot air blown out of the supply unit 52 to the outside of the box 50 can be prevented.

As is shown in FIG. 4, the windshield plate 60A is disposed between the exhaust outlet 58A and the supply unit 52, and the windshield plate 60B is disposed between the exhaust outlet 58B and the supply unit 52. The windshield plates 60A and 60B are disposed vertically below the support 16 and are placed underneath the support 16 with a predetermined gap S. The gap S is preferably ½ or less, especially preferably ¼ or less of a clearance between the tip of the nozzle and the web. The supply unit 52 and the exhaust outlets 58A and 58B are communicated only through these gaps and the vapor-containing hot air blown out of the supply unit 52 passes through the gap and is discharged through the exhaust outlets 58A and 58B. In addition, FIG. 4 depicts an example where the windshield plates 60A and 60B are disposed as one with the box 50 but the disposition is not limited to this; the windshield plates 60A and 60B may be disposed as separate, detachable members. In that case, the windshield plates 60A and 60B are preferably attached to the box 50 and configured so that they can be slid freely in a vertical direction and their height position (namely, the gap S) can be adjusted.

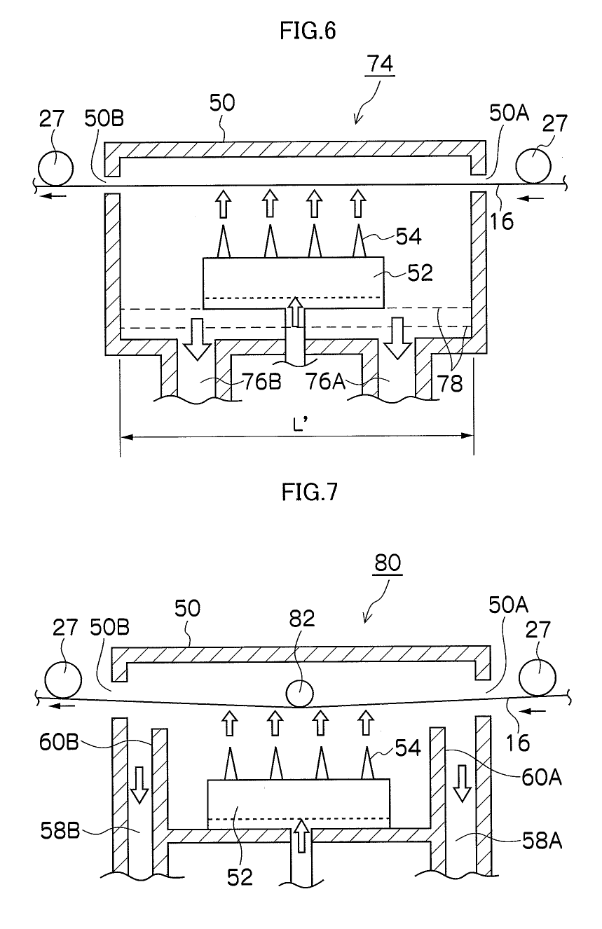

Next, functions of the drying apparatus configured as above will be described with reference to a comparative example illustrated in FIG. 6. In addition, the members in FIG. 6 having the same configurations and functions as those in the vapor atmosphere drying section 29 shown in FIG. 4 are denoted by the same symbols and explanation thereof will be omitted.

A vapor atmosphere drying section 74 of the comparative example shown in FIG. 6 has exhaust outlets 76A and 76B connected to underside of the box 50. Between these exhaust outlets 76A and 76B and the supply unit 52 are installed straightening vanes 78 such as punching plates. Thus, in the comparative example shown in FIG. 6, the positions of the exhaust outlets 76A and 76B are different from the positions of the exhaust outlets 58A and 58B in FIG. 4. Also, the configuration of the comparative example lacks the windshield plates 60A and 60B in FIG. 4.

In case of the vapor atmosphere drying section 74 of the comparative example thus configured, the vapor-containing hot air blown out of the supply unit 52 is known to be blown to the underside of the support 16 with the air volume concentrated at the center of a width direction of support 16. Thus, in case of the comparative example, drying proceeds well at the center of the width direction of support 16 but the first solvent tends to reside at the end portions of the width direction, thus causing a problem that uneven distribution of the residual first solvent occurs in the width direction. Especially, when the width, W (see FIG. 5), of the zone where the vapor atmosphere of the second solvent is formed is larger than the length L′ thereof (corresponds to L in FIG. 5), namely when W/L′≧1, there was a problem that uneven distribution of the residual first solvent occurred easily in the width direction.

In contrast, in the present embodiment shown in FIG. 4, the exhaust outlets 58A and 58B are disposed on both sides of the supply unit 52 along the conveying direction of the support 16 and, further, the windshield plates 60A and 60B are disposed between the supply unit 52 and the exhaust outlets 58A and 58B. Thus, the vapor-containing hot air blown out from the supply unit 52 passes through the gap between the windshield plates 60A and 60B and the support 16, and flows into the exhaust outlets 58A and 58B. Therefore, the vapor-containing hot air comes in contact with the underside of the support 16 nearly uniformly. This way, the first solvent contained in the film formed on the support 16 can be dried evenly in the width direction, making it possible to prevent occurrence of uneven distribution of the residual first solvent even in a range of “W/L≧1”, where uniform drying has been difficult by the conventional methods. In other words, even when L were made shorter to downsize the apparatus resulting in a larger value of W/L, occurrence of uneven distribution of the residual first solvent can be suppressed. Therefore, it becomes possible to plan downsizing of the vapor atmosphere drying section 29 and to increase the drying speed by raising the speed of the support 16.

Thus, according to the present embodiment, the exhaust outlets 58A and 58B are disposed on both sides of the supply unit 52, and the windshield plates 60A and 60B are disposed between these exhaust outlets 58A and 58B and the supply unit 52. Thus, occurrence of uneven distribution of the residual first solvent can be prevented and downsizing of the apparatus and increase in drying speed can be planned.

Also, according to the present embodiment, the supply unit 52, exhaust outlets 58A and 58B, and windshield plates 60A and 60B are placed below the support 16. Thus, even if dew-condensation occurred to the vapor-containing hot air, the droplets can be prevented from attaching to the support 16. Accordingly, quality deterioration of the support 16 because of the dew condensation can be avoided.

FIG. 7 is a cross-sectional view illustrating a configuration of a vapor atmosphere drying section 80 of a second embodiment. As shown in the figure, the vapor atmosphere drying section 80 of the second embodiment comprises a free rotating support roller 82 fixed inside the box 50. The support roller 82 is installed at the opposite side of the support 16 from the supply unit 52, namely above the support 16, and to this support roller 82, the support 16 is in contact with a predetermined lap angle. In addition, the position of the support roller 82 is preferably over the center of the supply unit 52 in the conveying direction of the support 16.

With the vapor atmosphere drying section 80 of the second embodiment thus configured, the uneven distribution of the residual first solvent is further improved when the vapor-containing hot air is blown from the supply unit 52 onto support 16. This is thought to be because the vapor-containing hot air is uniformly blown onto the surface of support 16 in the width direction, because installation of the support roller 82 removes warpage and looseness of support 16 and makes the clearance between the support 16 and nozzles 54 uniform in the width direction. Also, it may be pointed out as one of the reasons that, by installing the support roller 82, a flow of the vapor-containing hot air passing through the gaps between the windshield plates 60A, 60B and the support 16 becomes easier to be generated.

Thus, according to the present embodiment, disposition of the support roller 82 which comes in contact with the support 16 from the opposite side of the supply unit 52 can further improve uneven distribution of the residual first solvent.

In addition, even though only one support roller 82 was installed in the above-described second embodiment, the support roller is not limited to one and there may be disposed two or more support rollers.

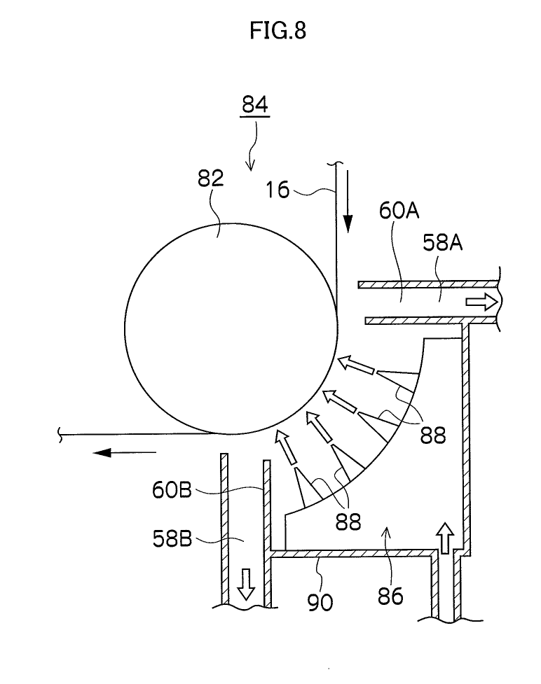

FIG. 8 is a cross-sectional view showing a configuration of a vapor atmosphere drying section 84 of a third embodiment. The vapor atmosphere drying section 84 of the third embodiment shown in FIG. 8 is different compared to the second embodiment shown in FIG. 7 in that a supply unit 86 is formed in a circular arc along the peripheral surface of the support roller 82. Also, the nozzles 88 are disposed facing support roller 82; more desirably, the vapor is blown nearly vertically onto the web so that energy loss is minimized. The apparatus shown in FIG. 8 is the most desirable embodiment in that the thermally insulated nozzles 88 are directed to the center of the support roller 82. In addition, this is also true with FIG. 4 and FIG. 6. In FIG. 8, a box 90 which houses the supply unit 86 has an opening only at a side facing the support roller 82 (namely, upper left in FIG. 8). Positioned in this opening, the support roller 82 is disposed. The exhaust outlets 58A and 58B are disposed at both sides (namely, the upper side and left side in FIG. 8) of the supply unit 86 in relation to the conveying direction of the support 16, and between the supply unit 86 and exhaust outlets 58A and 58B are disposed the windshield plates 60A and 60B.

In case of the third embodiment configured as above, also, uneven distribution of the residual first solvent contained in the film formed on the support 16 can be prevented because the vapor-containing hot air is blown from nozzles 88 of the supply unit 86 onto the support 16 uniformly in the width direction.

In the following, various materials used in the present embodiments will be described.

### [Support]

In the present invention, the material of the support is not particularly limited and may be metals, resins, papers, fabrics, and the like. Also, the shape of the support is not limited to a belt and may be one other than a belt.

Aluminum plates used for the lithographic printing plate precursors in the present embodiments are metal with dimensionally stable aluminum as the main component and comprise aluminum or aluminum alloys. Aside from pure aluminum plates, there may be used alloy plates comprising aluminum as the main component with minute amounts of different elements, or plastic films or paper which are laminated or vacuum-deposited with aluminum or aluminum alloys. Further, a composite sheet prepared by bonding an aluminum sheet to polyethylene terephthalate film may be used.

The composition of the aluminum plates used in the present embodiment is not particularly limited but use of a pure aluminum plate is preferred. However, because completely pure aluminum is difficult to manufacture in terms of a refining technology, aluminum containing trace amounts of different elements may be used. For example, aluminum of publicly known compositions described in “Aluminum Handbook”, 4th ed., Light Metal Association, 1990, specifically, for example, aluminum alloy plates defined in JIS A1050, JIS A1100, JIS A3003, JIS A3004, JIS A3005, and an internationally registered alloy 3103A may be used suitably. Also, aluminum plates made by use of an aluminum alloy, a scrap aluminum material, and secondary bare metal, containing aluminum in an amount of 99.4 to 95% by mass and three or more kinds of other elements selected from a group consisting of Fe, Si, Cu, Mg, Mn, Zn, and Ti may also be used.

The content of aluminum in the aluminum alloy plate is not particularly limited. However, preferably, the aluminum content may be 95 to 99.4% by mass and, further, the aluminum plate preferably contains three or more kinds of other elements selected from a group consisting of Fe, Si, Cu, Mg, Mn, Zn, Cr, and Ti in the following ranges. This is because such compositions afford aluminum having fine crystal grains. Fe: 0.20 to 1.0% by mass, Si: 0.10 to 1.0% by mass, Cu: 0.03 to 1.0% by mass, Mg: 0.1 to 1.5% by mass, Mn: 0.1 to 1.5% by mass, Zn: 0.03 to 0.5% by mass, Cr: 0.005 to 0.1% by mass, and Ti: 0.01 to 0.5% by mass. Also, the aluminum plate may contain elements such as Bi and Ni, and unavoidable impurities.

The process for manufacturing the aluminum plates may be either a continuous casting method or a DC casting method. Aluminum plates manufactured by the DC casting method from which an intermediate annealing treatment and a soaking treatment are omitted may also be used. Aluminum plates given irregularities by lamination rolling, transferring, or the like in the final rolling may be used. The aluminum plate used in the present embodiment may either be an aluminum support which is a continuous belt-like sheet material or a plate material. Or it can be also be a sheet cut into a size corresponding to the lithographic printing plate precursor which is shipped as a product.

The thickness of the aluminum plate used in the present embodiment is usually about 0.05 to 1 mm, preferably 0.1 to 0.5 mm. This thickness can be suitably varied according to the size of a printing machine, the size of a printing plate, and the user's wish.

In the manufacturing process of the support for the lithographic printing plate in the present embodiment, the support for the lithographic printing plate is obtained by providing the above-mentioned aluminum plate with surface treatments including at least surface roughening, anodizing, and specific sealing. Further, the surface treatment may include various other treatments. In addition, in the various steps of the present embodiment, the alloy components contained in the aluminum plate used are eluted in the treating liquids used in the respective steps. Thus, the treating liquid may contain the alloy components of the aluminum plate and, especially, it is favorable that the treating liquid is used in a steady state realized into by adding the alloy components prior to the treatment.

As the above-mentioned surface treatment, it is preferable to carry out an alkali etching treatment or a desmutting treatment, or both of the alkali etching and desmutting treatments in this order, before the electrolytic surface roughening. Also, it is preferable to, carry out an alkali etching treatment or a desmutting treatment, or both of the alkali etching and desmutting treatments in this order after the electrolytic surface roughening. Further, the alkali etching treatment after the electrolytic surface roughening may be omitted. Furthermore, it is preferable to provide a mechanical surface roughening treatment before these treatments. Also, the electrolytic surface roughening treatment may be repeated twice or more. Thereafter, it is also preferable to carry out anodizing, sealing, and hydrophilicizing treatments.

### [Second Solvent]

The second solvent used in the present embodiment is preferably a solvent having a smaller molecular volume than the first solvent described below. Such a solvent is generally a low-boiling point solvent, having preferably a boiling point not lower than 30° C. and not higher than 130° C. These low-boiling solvents include the following but the present invention is not limited to these. In parentheses are given the boiling points.

Alcohols such as methanol (64.5-64.65° C.), ethanol (78.32° C.), n-propanol (97.15° C.), isopropanol (82.3° C.), n-butanol (117.7° C.), isobutanol (107.9° C.); ethers such as ethyl ether (34.6° C.) and isopropyl ether (68.27° C.); ketones such as acetone (56.2° C.), methyl ethyl ketone (79.59° C.), methyl n-propyl ketone (103.3° C.), methyl isobutyl ketone (115.9° C.), diethyl ketone (102.2° C.); esters such as methyl acetate (57.8° C.), ethyl acetate (77.1° C.), n-propyl acetate (101.6° C.), n-butyl acetate (1265° C.); hydrocarbons such as n-hexane (68742° C.), cyclohexane (80.738° C.); water and the like.

### [First Solvent]

The first solvent used in the present embodiment is preferably a solvent having a boiling point of 150° C. or higher. As such high boiling point solvents, the following solvents may be mentioned but the present invention is not limited to these. In parentheses are given the boiling points.

γ-Butyrolactone (204° C.), acetamide (222° C.), 1,3-dimethyl-2-imidazolidinone (225.5° C.), N,N-dimethylformamide (153° C.), tetramethyl urea (175° C.-177° C.), nitrobenzene (211.3° C.), formamide (210.5° C.), N-methylpyrrolidone (202° C.), N,N-dimethylacetamide (166° C.), dimethyl sulfoxide (189° C.), and the like.

### [Image Forming Layer]

In the present invention, the lithographic printing plate precursors can be obtained by forming an image-forming layer on the treatment layer formed on the support as described above.

In the present invention, the image-forming layer formed herein may be any known layer but preferably it is one which can be recorded either in a heat mode or photon mode. From a standpoint of effectiveness, it is preferably an image forming layer which can form images by a heat mode exposure with an infrared laser and the like.

Also, the image-forming layer may comprise either a single layered structure or a multi-layered laminated structure.

Hereinafter, various lithographic printing plate precursors having different kinds of image forming layers will be described.

### [Lithographic Printing Plate Precursor Recordable by Infrared Laser]

Lithographic printing plate precursors suitable for the present invention, on which images can be formed with an infrared laser, will be described. These can employ any known image-recording system selected optionally, such as a negative- or positive-type image-forming layer using a material the solubility of which in an aqueous alkaline solution changes upon exposure to infrared laser light, an image-forming layer comprising a hydrophobizable precursor which can form ink-accepting region and forms a hydrophobic region corresponding to the area exposed to infrared laser light.

First, the positive- or negative-type image-forming layer will be described. These image-forming layers are classified into two types; after pattern exposure with infrared laser light, the image forming layer is developed by an alkaline aqueous solution, and when developability by alkali is lowered by irradiation of active light and the irradiated (exposed) portion becomes the image region, this is classified as the negative type; conversely, when developability by alkali is increased and the irradiated (exposed) region becomes the non-image region, this is classified as the positive type.

The positive-type image-forming layers include an interaction removal type (heat-sensitive, positive working) image-forming layer, a publicly known acid catalyst degrading type, an o-quinonediazide compound-containing type, and the like. These form the non-image region by the following mechanism: by an acid generated by irradiation of light or heating, or by thermal energy itself, the bonds of the polymeric compound which forms the layer are decomposed. The decomposed polymeric compound becomes soluble in water or alkaline water, and is removed by development to form the non-image region.

Further, the negative-type image-forming layer includes a publicly known acid catalyst crosslinking-type (including cationic polymerization) image forming layer and a polymerization cured-type image forming layer. These form image regions by a mechanism where an acid generated by irradiation of light or heating catalyzes a crosslinking reaction of the compounds constituting the image-forming layer, which cures to form the image region, or by a mechanism where radicals generated by irradiation of light or heating trigger a polymerization reaction of the polymerizable compounds, which cure to form the image region.

A specific intermediate layer in the present invention exhibits an excellent effect for any of the image-forming layers described above, but is suitably used for a positive-type image-forming layer.

In the following, each of the image forming layers will be described in detail.

### 1. Positive-Type Image Forming Layer

A preferable embodiment of the present invention includes a lithographic printing plate precursor comprising a positive-type image-forming layer, whereupon which comprises an alkali soluble resin and a sulfonium compound or an ammonium compound, where 50% by mass or more of the alkali soluble resin being a novolac resin, and which is recordable by an infrared laser. Further, in a more preferable embodiment, this positive-type image forming layer comprises an infrared absorber (A), which will be described later, in order to increase sensitivity. The positive type image forming layer may comprise a single layer or a laminated structure including a plurality of image-forming layers.

### [Novolac-Type Phenol Resin]

First, the novolac-type phenol resin will be described. The novolac resin refers to a resin prepared by polycondensation of at least one kind of phenols with at least one kind of aldehydes or ketones in the presence of an acid catalyst.

Here, the phenols include, for example, phenol, o-cresol, m-cresol, p-cresol, 2,5-xylenol, 3,5-xylenol, o-ethylphenol, m-ethylphenol, p-ethylphenol, propylphenol, n-butylphenol, tert-butylphenol, 1-naphthol, 2-naphthol, pyrocatechol, resorcinol, hydroquinone, pyrogallol, 1,2,4-benzenetriol, phloroglucinol, 4,4′-biphenyldiol, and 2,2-bis(4′-hydroxyphenyl)propane. Aldehydes include, for example, formaldehyde, acetaldehyde, propionaldehyde, benzaldehyde, and furfural. Ketones include, for example, acetone, methyl ethyl ketone, and methyl isobutyl ketone.

Preferably, the novolac resins are polycondensates of phenols selected from phenol, o-cresol, m-cresol, p-cresol, 2,5-xylenol, 3,5-xylenol, and resorcinol with aldehydes or ketones selected from formaldehyde, acetaldehyde, and propionaldehyde. Especially preferable are polycondensates of mixed phenols comprising m-cresol:p-cresol:2,5-xylenol:3,5-xylenol:resorcinol in a molar ratio of 40 to 100:0 to 50:0 to 20:0 to 20:0 to 20 or (mixed) phenols comprising phenols:m-cresol:p-cresol in a molar ratio of 0 to 100:0 to 70:0 to 60 with formaldehyde.

As these novolac resins, used are those with polystyrene-reduced weight average molecular weights as measured by gel permeation chromatography (hereinafter simply referred to as the “weight average molecular weight”) of preferably 500 to 20,000, more preferably 1,000 to 15,000, especially preferably 3,000 to 12,000. When the weight average molecular weight is in this range, the novolac resin shows a sufficient film forming property and the portion exposed to light exhibits excellent alkali developability.

When the aforementioned novolac resin is used as a binder resin of the image forming layer, the novolac resin may be used individually or in combination of more than two kinds. Also, the binder resin may contain the novolac resin solely or may comprise other resins used in combination. Even when other resins are used together, the novolac resin is preferably the main binder and the proportion of the novolac resin in the binder resin (alkali soluble resin) constituting the image forming layer is preferably 50% by mass or more, more preferably in a range of 65 to 99.9% by mass.

The binder resin which can be used in combination includes a generally used alkali soluble resin which is insoluble in water but soluble in alkali, and has acidic groups on at least one side of the main chain and side chain of the polymer. Phenol resins other than novolac resins, for example, resol resins, polyvinylphenol resins, and acrylic resins containing phenolic hydroxyl groups may also be used preferably. Specific resins which can be used in combination include those described in, for example, Japanese Patent Application Laid-Open No. 11-44956 and Japanese Patent Application Laid-Open No. 2003-167343.

### [Photothermal Conversion Agent]

The image forming layer of the present invention preferably comprises a photothermal conversion agent. As the photothermal conversion agents used herein, any material may be used without particular limitation on a range of its absorption wavelength as long as it absorbs light energy irradiation and emits heat. However, from a standpoint of suitability for an easy to obtain, high output laser, infrared absorbing dyes or pigments having absorption maxima in a wavelength range of 760 to 1200 nm are preferably mentioned.

The dyes include commercial dyes and such publicly known dyes as those described in literatures, for example, “Senryo Binran (Dye Handbook)”, Ed. Yuki Gosei Kagaku Kyokai, 1970 can be used. Specific examples include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squalilium pigments, pyrylium salts, metal thiolate complexes, oxonol dyes, diimmonium dyes, aminium dyes, and chloconium dyes.

Preferable dyes include, for example, cyanine dyes described in Japanese Patent Application Laid-Open Nos. 58-125246, Japanese Patent Application Laid-Open No. 59-84356, Japanese Patent Application Laid-Open No. 59-202829, and Japanese Patent Application Laid-Open No. 60-78787; methine dyes described in Japanese Patent Application Laid-Open No. 58-173696, Japanese Patent Application Laid-Open No. 58-181690, and Japanese Patent Application Laid-Open No. 58-194595; naphthoquinone dyes described in Japanese Patent Application Laid-Open No. 58-112793, Japanese Patent Application Laid-Open No. 58-224793, Japanese Patent Application Laid-Open No. 59-48187, Japanese Patent Application Laid-Open No. 59-73996, Japanese Patent Application Laid-Open No. 60-52940, Japanese Patent Application Laid-Open No. 60-63744; squalilium pigments described in Japanese Patent Application Laid-Open No. 58-112792; and cyanine dyes described in British Pat. No. 434,875.

Also, near-infrared absorbing sensitizers described in U.S. Pat. No. 5,156,938 may preferably be used. Further, preferably used are substituted arylbenzo(thio)pyrylium salts described in U.S. Pat. No. 3,881,924; trimethylthiapyrylium salts described in Japanese Patent Application Laid-Open No. 57-142645 (U.S. Pat. No. 4,327,169); pyrylium type compounds described in Japanese Patent Application Laid-Open Nos. 58-181051, 58-220143, 59-41363, 59-84248, 59-84249, 59-146063, 59-146061; cyanine pigments described in Japanese Patent Application Laid-Open No. 59-216146; pentamethinethiopyrylium salts described in U.S. Pat. No. 4,283,475; and pyrylium compounds disclosed in Japanese Examined Application Publication Nos. 5-13514 and 5-19702.

In addition, other examples of preferable dyes include the near-infrared absorbing dyes described by formulae (I) and (II) in U.S. Pat. No. 4,756,993.

Especially preferable among these dyes include the cyanine dyes, phthalocyanine dyes, oxonol dyes, squalilium dyes, pyrylium salts, thiopyrylium dyes, and nickel thiolate complexes. Further, compounds described in Japanese Patent Application Laid-Open No. 2005-99685, pp 26-38 are preferable because they exhibit excellent photothermal conversion efficiency. Especially, the cyanine dyes shown by a general formula (a) in Japanese Patent Application Laid-Open No. 2005-99685 is the most preferable because, when used in the photosensitive compositions of the present invention, they exhibit high interaction with alkali soluble resins and are excellent in stability and economic efficiency.

### [Degradable Dissolution Inhibitor]

To the positive-type image-forming layer of the present invention, there may be further added a degradable dissolution inhibitor. In order to improve the dissolution inhibiting property of the image region in the developer, it is especially preferable to use a substance (degradable dissolution inhibitor) in combination, such as an onium salt, an o-quinonediazide compound, and an alkyl sulfonate, which is thermally degradable and, in a state it is not decomposed, substantially lowers the solubility of the alkali soluble resin. Preferable as the degradable dissolution inhibitors are onium salts such as sufonium salts, ammonium salts, diazonium salts, and iodonium salts; and o-quinonediazide compounds. More preferable are sulfonium salts, ammonium salts, and diazonium salts.

Suitable onium salts used in the present invention include, for example, ammonium salts described in U.S. Pat. Nos. 4,069,055 and 4,069,056, Japanese Patent Application Laid-Open No. 3-140140, Japanese Patent Application Laid-Open No. 2006-293162, and Japanese Patent Application Laid-Open No. 2004-117546; and sulfonium salts described in J. V. Crivello et al, Polymer J. 17, 73 (1985), J. V. Crivello et al, J. Org. Chem., 43, 3055 (1978), W. R. Watt et al, J. Polymer Sci., Polymer Chem. Ed., 22, 1789 (1984), J. V. Crivello el al, Polymer Bull., 14, 279 (1985), J. V. Crivello el al, Macromolecules, 14(5), 1141 (1981), J. V. Crivello el al, J polymer Sci., Polymer Chem. Ed., 17, 2877 (1979), European Pat. Nos. 370,693, 233,567, 297,443, 297,442, U.S. Pat. Nos. 4,933,377, 3,902,114, 5,041,358, 4,491,628, 4,760,013, 4,734,444, 2,833,827, German Pat. Nos. 2,904,626, 3,604,580, 3,604,581, Japanese Patent Application Laid-Open No. 2006-293162, and Japanese Patent Application Laid-Open No. 2006-258979.

Also cited are diazonium salts described in S. I. Schlesinger, Photogr. Sci. Eng., 18, 387 (1974) and T. S. Bal et al, Polymer, 21, 423 (1980), and represented by the general formula (I) in Japanese Patent Application Laid-Open No. 5-158230 and the general formula (I) in Japanese Patent Application Laid-Open No. 11-143064.

Other preferable onium salts include phosphonium salt described in D. C. Necker et al, Macromolecules, 17, 2468 (1984), C. S. Wen et al, The Proc. Conf. Rad. Curing ASIA, p 478, Tokyo, October (1988), U.S. Pat. Nos. 4,069,055 and 4,069,056; iodonium salts described in J. V. Crivello et al, Macromolecules, 10(6), 1307 (1977), Chem. & Eng. News, November 28, p 31 (1988), European Pat. No. 104,143, U.S. Pat. Nos. 5,041,358 and 4,491,628, Japanese Patent Application Laid-Open No. 2-150848, Japanese Patent Application Laid-Open No. 2-296514; selenonium salts described in J. V. Crivello et al, Macromolecules, 10(6), 1307 (1977), J. V. Crivello et al, J. Polymer Sci., Polymer Chem. Ed., 17, 1047 (1979); arsonium salts described in C. S. Wen et al, The Proc. Conf. Rad. Curing ASIA, p 478, Tokyo, October (1988).

The counter ions of the onium salts include tetrafluoroborate, hexafluorophosphate, triisopropylnaphthalenesulfonate, 5-nitro-o-toluenesulfonate, 5-sulfosalicylate, 2,5-dimethylbenzenesulfonate, 2,4,6-trimethylbenzenesulfonate, 2-nitrobenzenesulfonate, 3-chlorobenzenesulfonate, 3-bromobenzenesulfonate, 2-fluorocaprylnaphthalenesulfonate, dodecylbenzenesulfonate, 1-naphthol-5-sulfonate, 2-methoxy-4-hydroxy-5-benzoyl-benzenesulfonate, p-toluenesulfonate, and the like. Among these, hexafluorophosphate and alkylaromaticsulfonate such as triisopropylnaphthalenesulfonate and 2,5-dimethylbenzenesulfonate are especially suitable.

These onium salts may be used singly or in combination of a plurality of compounds. Also, when the image-forming layer has a laminated structure, the onium salt may be added to a single layer or to a plurality of layers. Further, a plurality of kinds of compounds may each independently be added to different layers.

Suitable quinonediazides include an o-quinonediazide compound. The o-quinonediazide compound used in the present invention is a compound containing at least one o-quinonediazide group and, upon thermal decomposition, increases solubility in alkali. Compounds of various structures can be used. Namely, o-quinonediazide assists dissolution of light sensitive systems by two effects that it loses dissolution inhibiting ability for the binder upon thermal decomposition and that o-quinonediazide itself turns into an alkali soluble substance. As o-quinonediazide compounds used in the present invention, for example, those described in J. Kosar, “Light-Sensitive Systems”, John Wiley & Sons. Inc., pp 339-352 can be used; especially, sulfonic acid esters or sulfonic acid amides obtained by reacting o-quinonediazides with various aromatic polyhydroxy compounds or aromatic amino compounds are suitable. Further, used suitably are an ester of benzoquinone(1,2)-diazide-sulfonic acid chloride or naphthoquinone-(1,2)-diazide-5-sulfonic acid chloride with a pyrogallol-acetone resin described in Japanese Examined Application Publication No. 43-28403; and an ester of benzoquinone-(1,2)-diazidesulfonic acid chloride or naphthoquinone-(1,2)-diazide-5-sulfonic acid chloride with a phenol-formaldehyde resin described in U.S. Pat. Nos. 3,046,120 and 3,188,210.

Further, an ester of naphthoquinone-(1,2)-diazide-4-sulfonic acid chloride with phenol-formaldehyde resin or cresol-formaldehyde resin, and an ester of naphthoquinone(1,2)-diazide-4-sulfonic acid chloride and a pyrogallol-acetone resin may also be used suitably. Other useful o-quinonediazide compounds are reported in many patent documents and are known. Examples include those described in Japanese Patent Application Laid-Open No. 47-5303, Japanese Patent Application Laid-Open No. 48-63802, Japanese Patent Application Laid-Open No. 48-63803, Japanese Patent Application Laid-Open No. 48-96575, Japanese Patent Application Laid-Open No. 49-38701, Japanese Patent Application Laid-Open No. 48-13354, Japanese Examined Application Publication No. 41-11222, Japanese Examined Application Publication No. 45-9610, Japanese Examined Application Publication No. 49-17481, U.S. Pat. Nos. 2,797,213, 3,454,400, 3,544,323, 3,573,917, 3,674,495, 3,785,825, British Pat. Nos. 1,227,602, 1,251,345, 1,267,005, 1,329,888, 1,330,932, and German. Pat. No. 854,890.

The amount of addition of onium salts and/or o-quinonediazide compounds, which are degradable dissolution inhibitors, is preferably 0.1 to 10% by mass, more preferably 0.1 to 5% by mass, especially preferably 0.2 to 2% by mass, based on the total solids of the image forming layer according to the present invention. These compounds may be used singly or as a mixture of several kinds.

The amount of addition of additives other than o-quinonediazide compounds is preferably 0 to 5% by mass, more preferably 0 to 2% by mass, especially preferably 0.1 to 1.5% by mass. The additives and binders used in the present invention are preferably contained in the same layer.

Further, there may be used together a dissolution inhibitor which is not degradable. The preferable dissolution inhibitors include sulfonic acid esters, phosphoric acid esters, aromatic carboxylic acid esters, aromatic disulfones, carboxylic acid anhydrides, aromatic ketones, aromatic aldehydes, aromatic amines, aromatic ethers, which are described in detail in Japanese Patent Application Laid-Open No. 10-268512; acid color-forming dyes described in detail in Japanese Patent Application Laid-Open No. 11-190903, which comprise lactone skeletons, N,N-diarylamide skeletons, and diarylmethylimino skeletons, and also serve as colorants; nonionic surfactants described in detail in Japanese Patent Application Laid-Open No. 2000-105454; and the like.

### [Other Additives]

In the image-forming layer according to the present invention, for the purpose of improving the image discrimination (discrimination between hydrophobicity and hydrophilicity) or scratch resistance of the surface, there may be used together a polymer such as one described in Japanese Patent Application Laid-Open No. 2000-187318, comprising a (meth)acrylate monomer containing two or three perfluoroalkyl groups having 3 to 20 carbon atoms as a polymerizable component. The amount of such a compound to be added is preferably 0.1 to 10% by mass, more preferably 0.5 to 5% by mass based on the total solids of the image-forming layer according to the present invention.

In the image-forming layer according to the present invention, there can be added a compound which decreases the coefficients of surface friction in order to provide resistance to scratch. Specifically, there can be cited esters of long chain alkyl carboxylic acids and the like such as those used in U.S. Pat. No. 6,117,913. The amount of addition of such compound is preferably 0.1 to 10% by mass, more preferably 0.5 to 5% by mass, based on the total solids of the image-forming layer.

Further, in the image-forming layer according to the present invention, there may be contained, if necessary, a low molecular weight compound having an acidic group. The acidic group includes a sulfonic acid group, a carboxylic acid group, and a phosphoric acid group. Among them, a compound having a sulfonic acid group is preferable. Specific examples include aromatic sulfonic acids such as p-toluenesulfonic acid and naphthalenesulfonic acid, and aliphatic sulfonic acids.

In addition, in order to further increase the sensitivity, cyclic acid anhydrides, phenols, and organic acids may be used together. The cyclic acid anhydrides include those described in U.S. Pat. No. 4,115,128, such as phthalic anhydride, tetrahydrophthalic anhydride, hexahydrophthalic anhydride, 3,6-endoxy-Δ4-tetrahydrophtalic anhydride, tetrachlorophthalic anhydride, maleic anhydride, chloromaleic anhydride, α-phenylmaleic anhydride, succinic anhydride, pyromellitic anhydride, and the like. The phenols include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane, and the like. Further, the organic acids include those described in Japanese Patent Application Laid-Open No. 60-88942, Japanese Patent Application Laid-Open No. 2-96755, and the like, such as sulfonic acids, sulfinic acids, alkyl sulfuric acids, phosphonic acids, phosphoric acid esters, and carboxylic acids. Specifically, there may be mentioned p-toluenesulfonic acid, dodecylbenzenesulfonic acid, p-toluenesulfinic acid, ethyl sulfuric acid, phenyl phosphonic acid, phenyl phophinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, ascorbic acid, and the like.

When the acid anhydrides, phenols, and organic acid are added to the image-forming layer, their proportion in the image forming layer is preferably 0.05 to 20% by mass, more preferably 0.1 to 15% by mass, especially preferably 0.1 to 10% by mass.

Also, when preparing a coating liquid for the image-forming layer according to the present invention, in order to improve stability towards conditions of the developing treatment, there may be added nonionic surfactants such as those described in Japanese Patent Application Laid-Open No. 62-251740 and Japanese Patent Application Laid-Open No. 3-208514; amphoteric surfactants such as those described in Japanese Patent Application Laid-Open No. 59-121044, Japanese Patent Application Laid-Open No. 4-13149; siloxane type compounds such as those described in European Pat. No. 950517; and copolymers comprising a fluorine-containing monomer such as those described in Japanese Patent Application Laid-Open No. 11-288093.

Specific examples of nonionic surfactants include sorbitan tristearate, sorbitan monopalmitate, sorbitan trioleate, stearic acid monoglyceride, and polyoxyethylene nonylphenyl ether. Specific examples of amphoteric surfactants include alkyldi(aminoethyl)glycine, alkylpolyaminoethylglycine hydrochloric acid salt, 2-alkyl-N-carboxyethyl-N-hydroxyethylimidazolinium betaine, and N-tetradecyl-N,N-betaine type surfactant (for example, trade name “Amogen K”, manufactured by Daiichi Kogyo Seiyaku Co., Ltd.).

The siloxane type compounds preferably include block copolymers of dimethylsiloxane and polyalkylene oxides. Specific examples include polyalkylene oxide modified silicones such as DBE-224, DBE-621, DBE-712, DBP-732, and DBP-534, manufactured by Chisso Corp.; and Tego Glide 100 produced by Evonik Tego Chemie Gmbh, Germany.

The proportion of the aforementioned nonionic and amphoteric surfactants in the image-forming layer is preferably 0.05 to 15% by mass, more preferably 0.1 to 5% by mass.

To the image forming layer of the lithographic printing plate precursor of the present invention, there may be added a printing-out agent to obtain a visible image immediately after heating by light exposure. There may also be added a dye or a pigment as an image colorant.

A representative example of the printing-out agent includes a combination of a compound which releases an acid by heat evolved by light exposure (photo acid releasing agent) and an organic dye which can form a salt therewith. Specific examples include a combination of o-naphthoquinonediazide-4-sulfonic acid halogenide and a salt-forming organic dye, as described in Japanese Patent Application Laid-Open Nos. 50-36209 and 53-8128, and a combination of a trihalomethyl compound and a salt-forming organic dye, as described in Japanese Patent Application Laid-Open Nos. 53-36223, 54-74728, 60-3626, 61-143748, 61-151644, and 63-58440. These trihalomethyl compounds include oxazole type compounds and triazine type compounds, both of which have excellent temporal stability and provide clear printing-out images.

In addition to the salt-forming organic dyes described above, other may be used as the image-colorant. Suitable dyes including the salt-forming organic dyes comprise oil-soluble dyes and basic dyes. Specific examples include Oil Yellow #101, Oil Yellow #103, Oil Pink #312, Oil Green BG, Oil Blue BOS, Oil Blue #603, Oil Black BY, Oil Black BS, and Oil Black T-505 (these are manufactured by Orient Chemical Industries, Ltd.); Victoria Pure Blue, Crystal Violet (CI 42555), Methyl Violet (CI 42535), Ethyl Violet, Rhodamine B (CI 145170B), Malachite Green (CI 42000), Methylene Blue (CI 52015), and the like. Also, the dyes described in Japanese Patent Application Laid-Open No. 62-293247 are particularly preferable. These dyes may be added in a proportion of 0.01 to 10% by mass, preferably 0.1 to 3% by mass, based on the total solids of the image forming layer. Further, where necessary, there may be added a plasticizer to the coating liquid for the image-forming layer in order to provide flexibility and the like to the coated film. The plasticizers include, for example, butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate, and oligomers or polymers of acrylic acid or methacrylic acid.

Further, depending on the purpose, compounds other than the foregoing may be added suitably, such as epoxy compounds, vinyl ethers, phenol compounds having a hydroxymethyl group or an alkoxymethyl group, described in Japanese Patent Application Laid-Open No. 8-276558; and a cross-linkable compounds having a function of alkali dissolution inhibition, described in Japanese Patent Application Laid-Open No. 11-160860.

The thus-obtained image forming-layer in the image recording material of the present invention has an excellent film forming property and film strength, and upon exposure to infrared rays, the exposed portion shows high alkali solubility.

### 2. Negative-Type Image Forming Layer

2-1. Polymerization cured layer

As one of the negative-type image-forming layers, a polymerization cured layer may be mentioned. This polymerization cured layer comprises an infrared absorber (A), 10 a radical generator (a radical polymerization initiator) (B), radically polymerizable compounds (C) which initiate a polymerization reaction to cure by the generated radical, and preferably a binder polymer (D). The infrared rays absorbed by the infrared absorber is converted to heat. By this heat evolved, the radical polymerization initiator such as an onium salt and the like decompose to generate radicals. The radically polymerizable compound is selected from compounds containing at least one ethylenic unsaturated double bond and at least one, preferably two or more terminal ethylenic unsaturated double bonds; the compounds begins to polymerize by the generated radical in a chain reaction and cures.

### 2-2. Acid Crosslinkable Layer

Further, other embodiments of the image-forming layer includes an acid crosslinkable layer. The acid crosslinkable layer comprises a compound (E) which generates an acid by light or heat (hereinafter, referred to as an acid generator), a compound (F) which crosslinks by the acid generated (hereinafter, referred to as a crosslinking agent), and, further, an alkali soluble polymer (G) which forms a layer containing these compounds and can react with the crosslinking agent in the presence of an acid. In this acid crosslinkable layer, an acid generated by decomposition of the acid generator by irradiation of light or heating enhances activity of the crosslinking agent and a strong crosslinked structure is formed among the crosslinking agents or between the crosslinking agent and the binder polymer. Thus, solubility of the layer in alkali decreases and the layer becomes insoluble in the developer. Herein, in order to use energy of the infrared laser effectively, the infrared absorber (A) is compounded in the image forming layer.

### [Infrared Absorber (A)]

The image forming layer, which can form images by an infrared laser, comprises an infrared absorber. As the infrared absorber, any material can be used without any particular limitation on the range of absorption wavelength as long as it absorbs light energy irradiation used in recording and emits heat. However, from a standpoint of suitability for a readily available, high output laser, infrared-absorbing dyes and pigments having absorption maxima in a wavelength range of 800 to 1200 nm are preferably mentioned.

The dyes which can be used include commercial dyes and publicly known dyes described in literatures such as “Senryo Binran (Dye Handbook)”, Ed. Yuki Gosei Kagaku Kyokai (Society of Synthetic Organic Chemistry Japan), 1970 can be used. Specific examples include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squalilium dyes, pyrylium salts, and metal thiolate complexes.

Preferable dyes include, for example, cyanine dyes described in Japanese Patent Application Laid-Open No. 58-125246, Japanese Patent Application Laid-Open No. 59-84356, Japanese Patent Application Laid-Open No. 59-202829, and Japanese Patent Application Laid-Open No. 60-78787; methine dyes described in Japanese Patent Application Laid-Open No. 58-173696, Japanese Patent Application Laid-Open No. 58-181690, and Japanese Patent Application Laid-Open No. 58-194595; naphthoquinone dyes described in Japanese Patent Application Laid-Open No. 58-112793, Japanese Patent Application Laid-Open No. 58-224793, Japanese Patent Application Laid-Open No. 59-48187, Japanese Patent Application Laid-Open No. 59-73996, Japanese Patent Application Laid-Open No. 60-52940, and Japanese Patent Application Laid-Open No. 60-63744; squalilium dyes described in Japanese Patent Application Laid-Open No. 58-112792; cyanine dyes described in British Pat. No. 434,875.

Also, preferably used are near infrared-absorbing sensitizers described in U.S. Pat. No. 5,156,938; substituted arylbenzo(thio)pyrylium salts described in U.S. Pat. No. 3,881,924; trimethylthiapyrylium salts described in Japanese Patent Application Laid-Open No. 57-142645 (U.S. Pat. No. 4,327,169); pyrylium type compounds described in Japanese Patent Application Laid-Open Nos. 58-181051, 58-220143, 59-41363, 59-84248, 59-84249, 59-146063, and 59-146061; cyanine dyes described in Japanese Patent Application Laid-Open No. 59-216146; pentamethinethiopyrylium salts described in U.S. Pat. No. 4,283,475; pyrylium compounds disclosed in Japanese Examined Application Publication Nos. 5-13514 and 5-19702. In addition, other examples of preferable dyes include near infrared-absorbing dyes of formulae (I) and (II) described in U.S. Pat. No. 4,756,993.

Other preferable examples of the infrared-absorbing dyes of the present invention include specific indolenine cyanine dyes described in Japanese Patent Application No. 2001-6326 and Japanese Patent Application No. 2001-237840, such as those exemplified below.

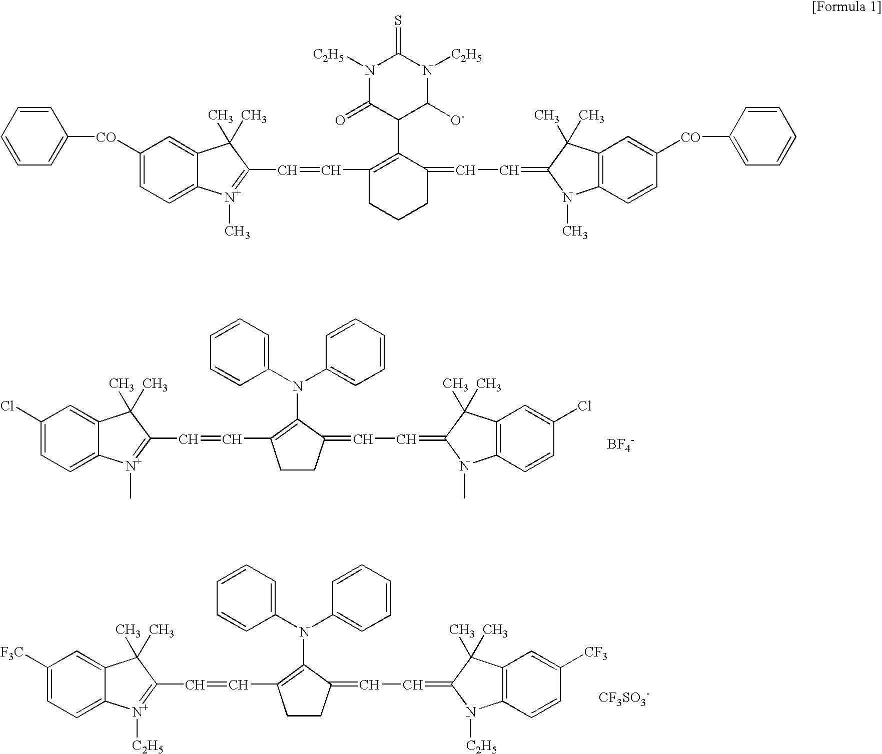

Especially preferable among these dyes include cyanine dyes, squalilium dyes, pyrylium salts, nickel thiolate complexes, and indolenine cyanine dyes. Further, the cyanine dyes and indolenine cyanine dyes are preferable. As one of especially preferable examples, cyanine dyes represented by the following general formula (A) are cited.

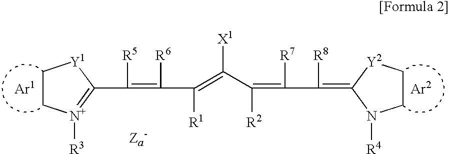

In the general formula (A), X¹ represents a hydrogen atom, a halogen atom, —NPh₂, X²-L¹, or the following groups. Here, X² represents an oxygen atom, a nitrogen atom, or a sulfur atom; L¹ represents a hydrocarbon group having 1 to 12 carbon atoms, a hetero atom-containing aromatic ring, a hetero atom-containing hydrocarbon group having 1 to 12 carbon atoms. In addition, the hetero atoms here include N, S, O, a halogen atom, and Se. Xa⁻ is defined in the same manner as Za⁻ which will be described later. Ra represents a substituent selected from a hydrogen atom, an alkyl group, an aryl group, a substituted or unsubstituted amino group, and a halogen atom.

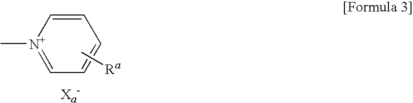

R¹ and R² each independently represent a hydrocarbon group having 1 to 12 carbon atoms. From a standpoint of storage stability of the coating liquid for the image-forming layer, R¹ and R² are preferably a hydrocarbon group having 2 or more carbon atoms, and further, R¹ and R² are, especially preferably, linked to each other to form a five- or six-membered ring.

Ar¹ and Ar² each represent an aromatic hydrocarbon group which may be the same or different and may have a substituent. Preferable aromatic hydrocarbon groups include a benzene ring and a naphthalene ring. Also, preferable substituents include a hydrocarbon group having 12 or less carbon atoms, a halogen atom, and an alkoxy group having 12 or less carbon atoms. Y¹ and Y² may be the same or different and represent a sulfur atom or a dialkylmethylene group having 12 or less carbon atoms. R³ and R⁴ are the same or different and each represent a hydrocarbon group having 20 or less carbon atoms, which may have a substituent. Preferable substituents include an alkoxy group having 12 or less carbon atoms, a carboxylic group, and a sulfo group. R⁵, R⁶, R⁷, and R⁸ may be the same or different and each represent a hydrogen atom or a hydrocarbon group having 12 or less carbon atoms. From a standpoint of availability of the raw material, a hydrogen atom is preferable. Also, Za⁻ represents a counter anion. However, when the cyanine dye represented by the general formula (A) has an anionic substituent within the structure and there is no need to neutralize the charge, then Za⁻ is not necessary. Preferable examples of Za⁻ include, from a standpoint of storage stability of the coating liquid for the image-forming layer, a halogen ion, a perchlorate ion, a tetrafluoroborate ion, a hexafluorophosphate ion, and a sulfonate ion. Among these, a perchlorate ion, a hexafluorophosphate ion, and an aryl sulfonate ion are especially preferable.

Specific examples of the cyanine dyes represented by the general formula (A), suitably used in the present invention, include those described in paragraph Nos. [0017] to [0019] of Japanese Patent Application Laid-Open No. 2001-133969.

Further, especially preferable other examples include specific indolenine cyanine dyes described in aforementioned Japanese Patent Application No. 2001-6326 and Japanese Patent Application No. 2001-237840.

The pigments suitable for use in the present invention include commercially available pigments and those described in, for example, “Karah Indekkusu Binran (C. I.) (Handbook of Color Index)”; “Saishin Ganryo Binran (Latest Pigment Handbook)”, Ed. Nihon Ganryo Gijutu Kyokai (Japan Association of Pigment Technologies), 1977; “Saishin Ganryo Oyo Gijutsu (Latest Pigment Application Technologies)”, CMC Publishing Co., Ltd., 1986; and “Insatsu Inki Gijutsu (Printing Ink Technologies)”, CMC Publishing Co. Ltd., 1984.

The types of pigments include black pigments, yellow pigments, orange pigments, brown pigments, red pigments, purple pigments, blue pigments, green pigments, fluorescent pigments, metal powder pigments, and polymer bound pigments. Specifically, there may be used insoluble azo pigments, azo lake pigments, condensed azo pigments, chelate azo pigments, phthalocyanine pigments, anthraquinone pigments, perylene and perinone pigments, thioindigo pigments, quinacridone pigments, dioxazine pigments, isoindolinone pigments, quinophthalone pigments, dyed lake pigments, azine pigments, nitroso pigments, nitro pigments, natural pigments, fluorescent pigments, inorganic pigments, and carbon black. Among these pigments, carbon black is preferable.

These pigments may be used with or without surface treatment. The methods of surface treatments include coating with a resin or wax, adhesion of a surfactant, and binding of a reactive substance (for example, a silane coupling agent, an epoxy compound, a polyisocyanate, and the like) to the pigment surface. These surface treating methods are described in “Kinzoku Sekken no Seishitu to Oyo (Properties and Applications of Metal Soaps)”, Saiwai Shobo Co., Ltd.; “Insatsu Inki Gijutsu (Printing Ink Technologies)”, CMC Publishing Co., Ltd., 1984; and “Saishin Ganryo Gijutsu (Latest Pigment Application Technologies)”, CMC Publishing Co., Ltd., 1986.

The diameter of the pigment is preferably 0.01 to 10 μm, more preferably 0.05 to 1 μm, and especially preferably 0.1 to 1 μm, from a standpoint of stability of dispersion thereof in the coating liquid for the image-forming layer and uniformity of the image-forming layer.

The methods for dispersing pigments include known dispersing techniques used in production of inks and toners. Examples of the dispersing machines include an ultrasonic dispersing machine, a sand mill, an attritor, a pearl mill, a super mill, a ball mill, an impeller, a disperser, a KD mill, a colloid mill, a dynatron, a three roll mill, and a pressurized kneader. Details are described in “Saishin Ganryo Oyo Gijutu (Latest Pigment Application Technologies)”, CMC Publishing Co. Ltd., 1986.

The amount of the infrared absorber contained in the image-forming layer is preferably 0.01 to 50% by mass, more preferably 0.1 to 10% by mass, most preferably 0.5 to 10% by mass, based on the mass of the total solids of the image forming layer. In this range, recording of high sensitivity is possible and no staining of the non-image region occurs, making high quality image formation possible.

### [Radical Generating Compound (B)]

A radical generator refers to a compound which generates radicals by energy of light, heat, or a combination of these, and initiates and enhances polymerization of compounds which have polymerizable unsaturated groups. The radical generators applicable to the present invention may be selected from known thermal polymerization initiators or compounds having low dissociation energy bonds. Examples include onium salts; organic halide compounds such as s-triazine compounds and oxazole compounds having trihalomethyl groups; peroxides; azo type polymerization initiators; arylazide compounds; carbonyl compounds such as benzophenones, acetophenones, and thioxanthones; metallocene compounds; hexaarylbiimidazole compounds; organoboron salt compounds; and disulfone compounds.

The radical generators used especially suitably in the present invention include onium salts. Above all, the onium salts represented by the following general formulae (B-1) to (B-3) are preferably used.

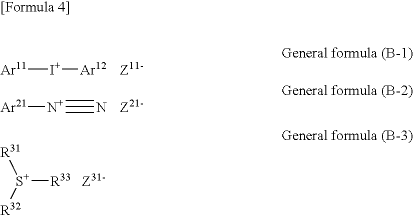

In formula (B-1), Ar¹¹ and Ar¹² each independently represent an aryl group having 20 or less carbon atoms, which may have a substituent. When this aryl group has a substituent, the preferable substituents include a halogen atom, a nitro group, an alkyl group having 12 or less carbon atoms, an alkoxy group having 12 or less carbon atoms, or an aryloxy group having 12 or less carbon atoms. Z¹¹⁻ represents an inorganic or organic anion.

In formula (B-2), Ar²¹ represents an aryl group having 20 or less carbon atoms, which may have a substituent. Preferable substituents include a halogen atom, a nitro group, an alky group having 12 or less carbon atoms, an alkoxy group having 12 or less carbon atoms, an aryloxy group having 12 or less carbon atoms, an alkylamino group having 12 or less carbon atoms, a dialkylamino group having 12 or less carbon atoms, an arylamino group having 12 or less carbon atoms, or a diarylamino group having 12 or less carbon atoms. Z²¹⁻ represents the same counter anion as Z¹¹⁻.

In formula (B-3), R³¹, R³², and R³³ may be the same or different and each represent a hydrocarbon group having 20 or less carbon atoms, which may have a substituent. Preferable substituents include a halogen atom, a nitro group, an alkyl group having 12 or less carbon atoms, an alkoxy group having 12 or less carbon atoms, or an aryloxy group having 12 or less carbon atoms. Z³¹⁻ represents the same counter anion as Z¹¹⁻.

In the general formulae (B-1) to (B-3), Z¹¹⁻, Z²¹⁻, and Z³¹⁻ represent an inorganic or organic anion. The inorganic anions include a halogen ion (F⁻, Cl⁻, Br⁻, I⁻), a perchlorate ion (ClO₄⁻), a perbromate ion (BrO₄⁻), a tetrafluoroborate ion (BF₄⁻), SbF₆⁻, PF₆⁻, and the like. The organic anions include an organic borate anion, a sulfonate ion, a phosphonate acid ion, a carboxylate ion, R⁴⁰—SO₃⁻, R⁴⁰—SO₂⁻, R⁴⁰—SO₂S⁻, a R⁴⁰—SO₂N⁻—Y—R⁴⁰ ion (here, R⁴⁰ represents an alkyl group having 1 to 20 carbon atoms or an aryl group having 6 to 20 carbon atoms; Y represents a single bond, —CO—, or —SO₂—), and the like.

In the present invention, specific examples of onium salts suitably used include those described in paragraph Nos. [0030] to [0033] of Japanese Patent Application Laid-Open No. 2001-133696.

The onium salts used in the present invention show maximum absorption preferably at a wavelength of 400 nm or shorter, more preferably 360 nm or shorter. By bringing the absorption wavelength into the ultraviolet light region, it becomes possible to perform handling of the lithographic printing plate precursor under white light.

These onium salts may be used singly or in combination of two or more kinds.

These onium salts may be added in a proportion of 0.1 to 50% by mass, preferably 0.5 to 30% by mass, especially preferably 1 to 20% by mass, based on total solids of the coating liquid for the image-forming layer. With the amount added in this range, high sensitivity recording is accomplished and occurrence of staining of the non-image portion during printing is suppressed.

These onium salts do not necessarily need to be added to the image-forming layer but may be added to another layer which is disposed adjacent to the image-forming layer.

### [Radical Polymerizable Compounds (C)]

The radically polymerizable compound used for the image-forming layer in the present embodiment is a radically polymerizable compound having at least one ethylenic unsaturated double bond and is selected from compounds having at least one, preferably two or more terminal ethylenic unsaturated bonds. This group of compounds is widely known in the related industrial filed and these compounds can be used without any particular limitation in the present invention. These have chemical forms such as a monomer; a prepolymer, namely dimer, trimer, and oligomer, or a mixture thereof; or a copolymer thereof. Examples of monomers and copolymers thereof include unsaturated carboxylic acids (for example, acrylic acid, methacrylic acid, itaconic acid, crotonic acid, isocrotonic acid, and maleic acid), and esters and amides thereof. Preferably used are esters of unsaturated carboxylic acids with aliphatic polyhydric alcohols, and amides of unsaturated carboxylic acids with aliphatic polyfunctional amines are used. Also, addition reaction products of unsaturated carboxylic acid esters or amides, having nucleophilic substituent such as hydroxyl groups, amino groups, and mercapto groups, to mono- or poly-functional isocyanates or epoxies, or dehydration condensation product thereof with mono- or poly-functional carboxylic acids are used preferably. Further, suitable are addition reaction products of unsaturated carboxylic acid esters and amides, having electrophilic substituents such as isocyanate groups or epoxy groups, with mono- or poly-hydric alcohols, amines, and thiols, and, further, substitution reaction products of unsaturated carboxylic acid esters and amides, having leaving substituents such as halogen groups and tosyloxy groups, with mono- or poly-functional alcohols, amines, and thiols. Also, as another example, it is possible to use a group of compounds, which are obtained by replacing the unsaturated carboxylic acids mentioned above with unsaturated phosphonic acids, styrene, and the like.

Specific examples of acrylic acid esters, methacrylic acid esters, itaconic acid esters, crotonic acid esters, isocrotonic acid esters, and maleic acid esters, which are radically polymerizable compounds, i.e., esters between aliphatic polyhydric alcohol compounds and unsaturated carboxylic acids, are described in paragraph Nos. [0037] to

of Japanese Patent Application Laid-Open No. 2001-133696 and are applicable to the present invention.

Examples of other esters, which can also be used suitably, include, for example, esters based on aliphatic alcohols, described in Japanese Examined Application Publication No. 46-27926, Japanese Examined Application Publication No. 51-47334, Japanese Patent Application Laid-Open No. 57-196231; those having aromatic skeletons, described in Japanese Patent Application Laid-Open No. 59-5240, Japanese Patent Application Laid-Open No. 59-5241, Japanese Patent Application Laid-Open No. 2-226149; and those having amino groups, described in Japanese Patent Application Laid-Open No. 1-165613.

Further, specific examples of amide monomers obtained from aliphatic polyfunctional amines and unsaturated carboxylic acids include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Other preferable examples of amide type monomers include those having a cyclohexylene structure described in Japanese Examined Application Publication No. 54-21726.

Also, urethane type addition polymerizable compounds manufactured by addition reactions of isocyanates and hydroxyl groups are also suitable. Specific examples of such compounds include vinyl urethane compounds described, for example, in Japanese Examined Application Publication No. 48-41708, containing two or more polymerizable vinyl groups, which are obtained by addition of hydroxyl group-containing vinyl monomers represented by the following general formula (VI) to polyisocyanate compounds having two or more isocyanate groups in one molecule. General formula (VI):

CH₂═C(R⁴¹)COOCH₂CH(R⁴²)OH

wherein R⁴¹ and R⁴¹ represent H or CH₃.

Further, suitable are urethane acrylates described in Japanese Patent Application Laid-Open No. 51-37193, Japanese Examined Application Publication No. 2-32293, and Japanese Examined Application Publication No. 2-16765; and urethane compounds having ethylene oxide type skeletons, described in Japanese Examined Application Publication No. 58-49860, Japanese Examined Application Publication No. 56-17654, Japanese Examined Application Publication No. 62-39417, and Japanese Examined Application Publication No. 62-39418.

Furthermore, there may be used radically polymerizable compounds having an amino structure or a sulfide structure in the molecule, which are described in Japanese Patent Application Laid-Open No. 63-277653, Japanese Patent Application Laid-Open No. 63-260909, and Japanese Patent Application Laid-Open No. 1-105238.

Other examples include polyfunctional acrylates and methacrylates such as polyester acrylates and epoxy acrylates, the latter being obtained by a reaction of an epoxy resin and (meth)acrylic acid, which are described in Japanese Patent Application Laid-Open No. 48-64183, Japanese Examined Application Publication No. 49-43191, Japanese Examined Application Publication No. 52-30490. Also mentioned are specific unsaturated compounds described in Japanese Examined Application Publication No. 46-43946, Japanese Examined Application Publication No. 1-40337, and Japanese Examined Application Publication No. 1-40336; and vinyl phosphonic acid based compounds described in Japanese Patent Application Laid-Open No. 2-25493. Also, in some cases, a structure containing a perfluoroalkyl group, described in Japanese Patent Application Laid-Open No. 61-22048, may be used suitably. Further, those introduced as photo curable monomers and oligomers in Nippon Secchaku Kyokaishi (Journal of Japan Adhesion Society), 20(7), 300-308 (1984) may also be used.

Regarding these radically polymerizable compounds, details of usage thereof, such as what kind of structure should be used, whether it should be used singly or in combination, or how much amount should be used, can be optionally set according to the final performance design of the recording material. For example, the compounds are selected based on the following viewpoints. In terms of sensitivity, a structure having a higher content of unsaturated groups per molecule is preferable and, in many cases, those with two or more functional groups are preferable. Also, in order to increase strength of the image region, i.e., the cured film, use of monomers with three or more functional groups is preferred. Further, to use compounds having a different number of functional groups and polymerizable groups (for example, acrylic acid esters, methacrylic acid esters, styrenic compounds, and the like) in combination are effective to adjust both photosensitivity and film strength. Compounds of large molecular weights and compounds of high hydrophobicity are excellent in sensitivity and film strength but, on the other hand, they are sometimes undesirable in terms of development speed and precipitation in the developer. Also, with regard to compatibility with and dispersibility in other components in the image-forming layer (for example, the binder polymer, initiator, and colorant), choice and usage of the radically polymerizable compound are important factors. For example, use of low purity compounds and simultaneous use of two or more compounds may sometimes improve compatibility. Further, there may be a case where a specific structure is selected in order to improve adhesion with the support, an overcoat layer and the like. As for the compounding ratio of the radically polymerizable compounds in the image-forming layer, the higher ratio is advantageous to sensitivity, but if the ratio is too high, there may occur undesirable phase separation, and there may arise problems such as one which occurs during the manufacturing process due to stickiness of the image-forming layer (for example, defective products because of transfer or sticking of components of the image-forming layer) or one that precipitation occurs from the developer.

From these viewpoints, a preferable compounding ratio of the radically polymerizable compounds is, in many cases, 5 to 80% by mass, preferably 20 to 75% by mass, based on the total components of the compound. Also, these may be used singly or in a combination of two or more kinds. In addition, regarding usage of the radically polymerizable compounds, a suitable structure, formulation, and amount of addition thereof may be selected optionally from such standpoints as the degree of polymerization inhibition by oxygen, resolution, fogging, change in refractive index, surface tackiness, and the like. Further, in some cases, a layered structure and coating method such as an undercoat or overcoat may be performed.

### [Binder Polymer (D)]

In the image-forming layer, it is preferable to use a binder polymer from a standpoint of improving the film characteristics of the image-forming layer and, as the binder, a linear organic polymer is preferably used. As the “linear organic polymer”, any polymer may be used but, preferably, in order to make water or weakly alkaline water development possible, a linear organic polymer which is soluble or swellable in water or a weakly alkaline water is selected. The linear organic polymer is selectively used depending on application, not only as a film-forming material for forming the image-forming layer but also as a developable material with water, weakly alkaline water, or an organic solvent.

For example, if a water-soluble organic polymer is used, development by water becomes possible. Such a linear organic polymer includes radically polymerized polymers having carboxylic groups on the side chain, such as those described in Japanese Patent Application Laid-Open No. 59-44615, Japanese Examined Application Publication No. 54-34327, Japanese Examined Application Publication No. 58-12577, Japanese Examined Application Publication No. 54-25957, Japanese Patent Application Laid-Open No. 54-92723, Japanese Patent Application Laid-Open No. 59-53836, Japanese Patent Application Laid-Open No. 59-71048; namely methacrylic acid copolymers, acrylic acid copolymers, itaconic acid copolymers, crotonic acid copolymers, maleic acid copolymers, partially esterified maleic acid copolymers, and the like. Likewise, there may also be mentioned acidic cellulose derivatives, having carboxylic acid groups on the side chains. In addition to these, useful are polymers having hydroxyl groups to which cyclic anhydrides and the like have been added.

Especially suitable among these are (meth)acrylic resins having benzyl or allyl groups, and carboxylic groups on the side chains, which have an excellent balance of film strength, sensitivity, and developability.

Also, urethane type binder polymers having acid groups, described in Japanese Examined Application Publication No. 7-12004, Japanese Examined Application Publication No. 7-120041, Japanese Examined Application Publication No. 7-120042, Japanese Examined Application Publication No. 8-12424, Japanese Patent Application Laid-Open No. 63-287944, Japanese Patent Application Laid-Open No. 63-287947, Japanese Patent Application Laid-Open No. 1-271741, Japanese Patent Application Laid-Open No. 11-352691, and the like have excellent strength and are favorable in terms of printing endurance and low exposure suitability.

Further, in addition to these, poly(vinyl pyrrolidone), poly(ethylene oxide), and the like are useful as water-soluble linear organic polymers. Also, in order to increase strength of the cured film, alcohol-soluble nylon, a polyether obtained from 2,2-bis(4-hydroxyphenyl)propane and epichlorohydrin, and the like are also useful.

The weight average molecular weights of polymers used in the present invention are preferably 5,000 or larger, more preferably in a range of 10,000 to 300,000. The number average molecular weights are preferably 1,000 or larger, more preferably in a range of 2,000 to 250,000. The polydispersity indices (weight average molecular weight/number average molecular weight) are preferably 1 or larger, more preferably in a range of 1.1 to 10.

These polymers may be any of random polymers, block polymers, graft polymers, and the like. However, random polymers are preferable.

The binder polymers used in the present invention may be used singly or as a mixture. These polymers are added to the image forming-layers in a proportion of 20 to 95% by mass, preferably 30 to 90% by mass, based on the total solids of the coating liquid for the image-forming layer. When the amount added is less than 20% by mass, strength of the image region becomes deficient after formation of the images. Also, when the amount added exceeds 95% by mass, no image is formed. Further, the ratio of the radically polymerizable compound having ethylenic unsaturated double bond to the linear organic polymer is preferably in a range of 1/9 to 7/3 by mass.

Next, constituent components of the acid crosslinkable layer will be described. The infrared absorber used here includes the same compounds as those described for the polymerization cured image forming layer.

Preferable content of the infrared absorber is preferably 0.01 to 50% by mass, more preferably 0.1 to 10% by mass, most preferably 0.5 to 10% by mass, based on the mass of the total solids of the image-forming layer.

In the range of content mentioned above, high sensitivity recording is attained and, further, occurrence of smudging on the non-image region of the lithographic printing plate is suppressed.

### [Acid Generator (E)]

In the present embodiment, the acid generator, which generates an acid upon decomposition by heat, refers to a compound which generates an acid by irradiation of light in a wavelength range of 200 to 500 nm or by heating to a temperature of 100° C. or higher.

The acid generators include known compounds, mixtures thereof, and the like which can generate an acid by thermal decomposition, such as a photo-initiator for photocationic polymerization, a photo-initiator for photoradical polymerization, an optical decolorizer for dyes, and a photodiscoloration agent, or known photoacid generators used in micro resists, and the like.

Among the acid generators mentioned above, compounds represented by the following general formulae (E-1) to (E-5) are preferable.

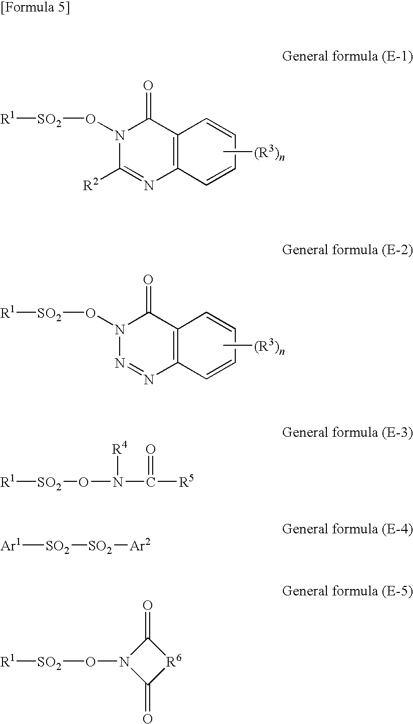

In the general formulae (E-1) to (E-5), R¹, R², R⁴, and R⁵ may be the same or different and represent a hydrocarbon group having 20 or less carbon atoms, which may have a substituent; R³ represents a halogen atom, a hydrocarbon group having 10 or less carbon atoms or an alkoxy group having 10 or less carbon atoms or less, both of which may have a substituent; Ar¹ and Ar² may be the same or different and represent aryl groups having 20 or less carbons, which may have a substituent; R⁶ represents a bivalent hydrocarbon group having 20 carbons or less, which may have a substituent; n represents an integer of 0 to 4.

In the aforementioned formulae, R¹, R², R⁴, and R⁵ are preferably hydrocarbon groups having 1 to 14 carbon atoms.

Preferable embodiments of the acid generators represented by the general formulae (E-1) to (E-5) are described in detail in paragraph Nos. [0197] to [0222] of Japanese Patent Application Laid-Open No. 2001-142230 as compounds of the general formulae (I) to (V). These compounds can be synthesized, for example, according to methods described in Japanese Patent Application Laid-Open No. 2-100054 and Japanese Patent Application Laid-Open No. 2-100055.

Further, as acid generators (E), onium salts having halide ions or sulfonate ions as counter ions may also be cited. Among them, compounds having any of structural formulae of iodonium salts, sulfonium salts, diazonium salts, represented by the following general formulae (E-6) to (E-8), are preferably mentioned.

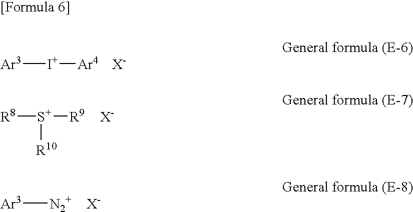

In the general formulae (E-6) to (E-8), X⁻ represents a halide ion, ClO₄⁻, PF₆⁻, SbF₆⁻, BF₄⁻, or R⁷SO₃⁻, here R₇ representing a hydrocarbon group having 20 or less carbon atoms, which may have a substituent; Ar³ and Ar⁴ each independently represent an aryl group having 20 or less carbon atoms, which may have a substituent. R⁸, R⁹, and R¹⁰ represent a hydrocarbon group having 18 or less carbon atoms, which may have a substituent.

These onium salts are described in paragraph Nos. [0010] to [0035] of Japanese Patent Application Laid-Open No. 10-39509 as compounds represented by the general formulae (I) to (III).

The amount of acid generator added is preferably 0.01 to 50% by mass, more preferably 0.1 to 25% by mass, most preferably 0.5 to 20% by mass, based on the total solid mass of the image-forming layer.

If the amount added is less than 0.01% by mass, there may be a case where no image is formed. If the amount exceeds 50% by mass, smudging may occur to the non-image region during printing after preparation of the lithographic printing plate precursor.

The aforementioned acid generators may be used singly or in combination of two or more kinds.

### [Crosslinking Agents (F)]

In the following, the crosslinking agents will be described. The crosslinking agents include the following:

(i) aromatic compounds substituted by hydroxymethyl groups or alkoxymethyl groups,

(ii) compounds having N-hydroxymethyl groups, N-alkoxymethyl groups, or N-acyloxymethyl groups, and

(iii) epoxy compounds.

Hereinafter, the compounds (i) to (iii) will be described in detail.

The aforementioned aromatic compounds (i) substituted by hydroxymethyl groups or alkoxymethyl groups include, for example, aromatic compounds or heterocyclic compounds which are polysubstituted by hydroxymethyl groups, acetoxymethyl groups, or alkoxymethyl groups. Here, resinous compounds known as resol resins, obtained by condensation polymerization of phenols and aldehydes under basic conditions, are also included.

Among the aromatic compounds or heterocyclic compounds polysubstituted by hydroxymethyl groups or alkoxymethyl groups, compounds having hydroxymethyl groups or alkoxymethyl groups at positions next to hydroxyl groups are above all preferable.

Among the aromatic compounds or heterocyclic compounds polysubstituted by alkoxymethyl groups, compounds with alkoxymethyl groups having 18 carbon atoms or less are above all preferable. More preferable are the compounds represented by the following general formulae (F-1) to (F-4).

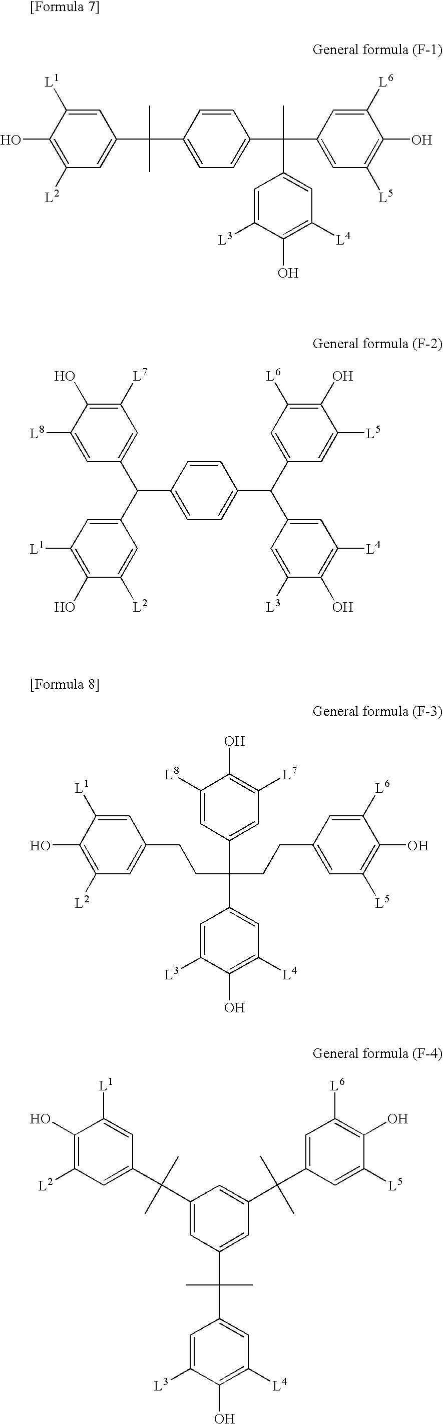

In the general formulae (F-1) to (F-4), L¹ l to L⁸ each independently represent a hydroxymethyl group or an alkoxymethyl group substituted with an alkoxy group having 18 carbon atoms or less, such as methoxymethyl, ethoxymethyl, and the like.

These crosslinking agents are preferable because they exhibit high crosslinking efficiency and can improve printing endurance.

Compounds (ii) having N-hydroxymethyl groups, N-alkoxymethyl groups, or N-acyloxymethyl groups include monomeric and oligomeric melamine-formaldehyde condensates and urea-formaldehyde condensates described in European Patent Laid-Open (hereinafter denoted as “EP-A”) No. 0,133,216, West German Pat. Nos. 3,634,671 and 3,711,264; and alkoxy substituted compounds and the like described in EP-A No. 0,212,482.

Among these, for example, melamine-formaldehyde derivatives having at least two free N-hydroxymethyl groups, N-alkoxymethyl groups, or N-acyloxymethyl groups are preferable, with N-alkoxymethyl derivatives being the most preferable.

The epoxy compounds (iii) include monomeric, dimeric, oligomeric, and polymeric epoxy compounds having at least one epoxy group. Examples include, for example, a reaction product of bisphenol-A and epichlorohydrin, and a reaction product of a low molecular weight phenol-formaldehyde resin and epichlorohydrin.

In addition, there may be mentioned epoxy resins described and used in U.S. Pat. No. 4,026,705 and British Pat. No. 1,539,192.

When the compounds (i) to (iii) described above are used as the crosslinking agents, the amount added is preferably 5 to 80% by mass, more preferably 10 to 75% by mass, most preferably 20 to 70% by mass, based on the total solid mass of the image-forming layer.

If the amount added is less than 5% by mass, durability of the obtained image-forming layer of the image recording material may sometimes deteriorate; and when the amount added exceeds 80% by mass, storage stability of the image-forming layer may sometimes go down.

In the present invention, the phenol derivatives (iv) represented by the following general formula (F-5) can also be used suitably:

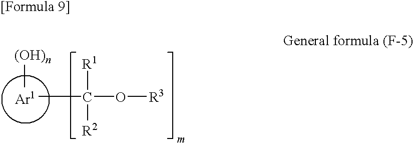

In the general formula (F-5), Ar¹ represents an aromatic hydrocarbon ring, which may have a substituent; R¹, R², and R³ represent a hydrogen atom or a hydrocarbon group having 12 or less carbon atoms; m is an integer from 2 to 4; and n is an integer from 1 to 3.

From a viewpoint of raw material availability, the above-mentioned aromatic hydrocarbon ring is preferably a benzene ring, a naphthalene ring, or an anthracene ring. Further, as the substituents thereof, preferred are a halogen atom, a hydrocarbon group having 12 or less carbon atoms, an alkoxy group having 12 or less carbon atoms, an alkylthio group having 12 or less carbon atoms, a cyano group, a nitro group, a trifluoromethyl group, and the like.

Among the foregoing, considering the possibility of achieving higher sensitivity, Ar¹ is preferably a non-substituted benzene or naphthalene ring; or a substituted benzene or naphthalene ring having, as a substituent, a halogen atom, a hydrocarbon group having 6 or less carbon atoms, an alkoxy group having 6 or less carbon atoms, an alkylthio group having 6 or less carbon atoms, an alkylcarbamoyl group having 12 or less carbon atoms, a nitro group, and the like.

The hydrocarbon group represented by R¹ and R² is preferably a methyl group by reason of easiness of synthesis. The hydrocarbon group represented by R³ is preferably a hydrocarbon group having 7 or less carbon atoms such as a methyl group and a benzyl group by reason of high sensitivity. Further, from a standpoint of easiness of synthesis, m is preferably 2 or 3, and n is preferably 1 or 2.

### [Alkaline Water Soluble Polymer Compounds (G)]

Polymer compounds soluble in alkaline water, which can be used in the crosslinkable layer applicable to the present invention, includes novolac resins, polymers having hydroxyaryl groups as side chains, and the like. The novolac resins include the resins obtained by condensation of phenols and aldehydes under acidic conditions. Preferable among them are, for example, a novolac resin obtained from phenol and formaldehyde; a novolac resin obtained from m-cresol and formaldehyde; a novolac resin obtained from p-cresol and formaldehyde; a novolac resin obtained from o-cresol and formaldehyde; a novolac resin obtained from octylphenol and formaldehyde; a novolac resin obtained from m/p-mixed cresol and formaldehyde; a novolac resin obtained from a phenol/cresol (any mixture of m-, p-, and o-; or m-/p-, m-/o-, o-/p-) mixture and formaldehyde; a high ortho bonding, high molecular weight novolac resin obtained from a catalyst-free reaction of phenol and paraformaldehyde under high pressure in a closed vessel.

As the aforementioned novolac resin, one suitable for the purpose is selected from those having weight average molecular weights of 800 to 300,000 and number average molecular weights of 400 to 60,000.

Also, the polymers having hydroxyaryl groups as side chains are preferable, where the hydroxyaryl group in the polymers includes an aryl group to which is bonded at least one OH group.

The aryl group mentioned above includes, for example, a phenyl group, a naphthyl group, an anthracenyl group, and a phenanthrenyl group. Among these, from a standpoint of ready availability and physical properties, a phenyl group or a naphthyl group is preferable.

The polymer having hydroxyaryl groups as side chains, usable in the present embodiment, includes, for example, a polymer comprising any one of the constituent units represented by the following general formulae (G-1) to (G-4). However,the present invention is not limited to these.

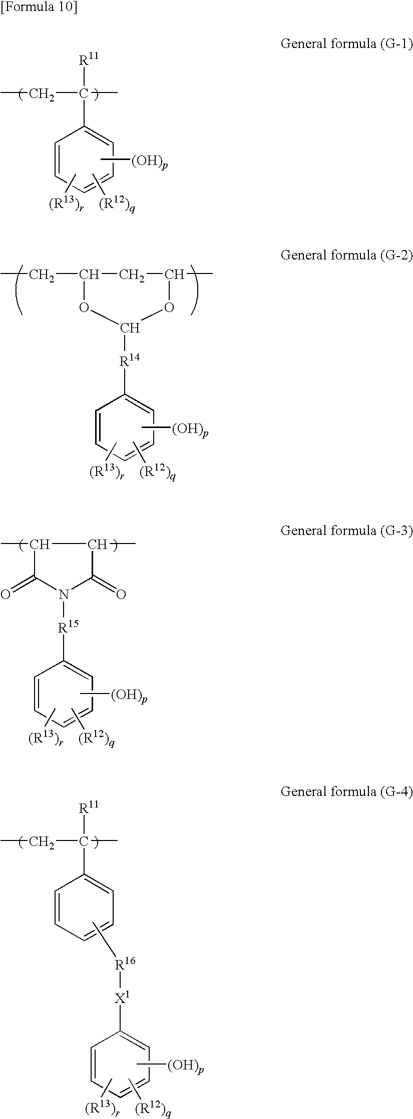

In the general formula (G-1) to (G-4), R¹¹ represents a hydrogen atom or a methyl group; R¹² and R¹³ may be the same or different and represent a hydrogen atom, a halogen atom, a hydrocarbon group having 10 carbon atoms or less, an alkoxy group having 10 carbons or less, an aryloxy group having 10 carbon atoms or less; also, R¹² and R¹³ may be mutually bonded and fused to form a ring such as a benzene ring or a cyclohexane ring; R¹⁴ represents a single bond or a bivalent hydrocarbon group having 20 carbon atoms or less; R¹⁵ represents a single bond or a bivalent hydrocarbon group having 20 carbon atoms or less; R¹⁶ represents a single bond or a bivalent hydrocarbon group having 10 carbon atoms or less; X¹ represents a single bond, ether bond, thioether bond, ester bond, or amide bond; p represents an integer from 1 to 4; q and r each independently represents an integer from 0 to 3.

These alkali soluble polymers are described in detail in paragraph Nos. [0130] to [0163] of Japanese Patent Application Laid-Open No. 2001-142230.

The polymer compounds soluble in alkaline water, usable in the present embodiment, may be used singly or in a combination of two or more kinds.

The amount of addition of the polymer soluble in alkaline water is preferably 5 to 95% by mass, more preferably 10 to 95% by mass, most preferably 20 to 90% by mass, based on the total solids of the image forming layer.

If the amount of addition of the alkaline water-soluble polymer is less than 5% by mass, durability of the image-forming layer may deteriorate in some cases; if it exceeds 95% by mass, no image may be formed sometimes.

Further, known recording materials applicable to the image-forming layer according to the present invention includes a negative-type image-recording material containing phenol derivatives, described in Japanese Patent Application Laid-Open No. 8-276558; a negative-type recording material containing diazonium compounds, described in Japanese Patent Application Laid-Open No. 7-306528; a negative-type image-forming material described in Japanese Patent Application Laid-Open No. 10-203037, which uses a polymer having a heterocyclic group with an unsaturated bond included therein and utilizes an acid-catalyzed crosslinking reaction. The image-forming layers described in these documents can be applied to the acid crosslinking layer which is the negative-type image-forming layer in the present invention.

### [Other Components]

To such negative-type image-forming layers, there may further be added, according to necessity, various compounds in addition to those mentioned above. For example, a dye having a large absorption in the visible light region may be used as an image colorant. Also, pigments such as phthalocynine pigments, azo pigments, carbon black, and titanium oxide may be used suitably.

Further, in the present invention, when the image-forming layer is a polymerization cured layer, it is preferable to add a small amount of a thermal polymerization inhibitor in order to prevent unnecessary thermal polymerization of a radically polymerizable compound having an ethylenic unsaturated double bond, polymerization occurring during preparation of the coating liquid or during storage. Suitable thermal polymerization inhibitors include hydroquinone, p-methoxyphenol, di-t-butyl-p-cresol, pyrrogallol, t-butylcatechol, benzoquinone, 4,4′-thiobis(3-methyl-6-t-butylphenol), 2,2′-methylenebis(4-methyl-6-t-butylphenol), N-nitroso-N-phenylhydroxylamine aluminum salt, and the like. The amount of thermal polymerization inhibitor to be added is preferably ca. 0.01 to ca. 5% by mass based on the mass of the total composition. Also, in order to prevent polymerization inhibition by oxygen, higher fatty acid derivatives such as behenic acid or a behenic acid amide may be added according to necessity, which will become distributed mainly on the surface of the image-forming layer during the drying process after coating. The amount of higher fatty acid derivative to be added is ca. 0.1 to ca. 10% by mass based on the total composition.

Also, in order to improve stability towards conditions of developing treatment, there may be added to the coating liquid for the image-forming layer of the present invention, nonionic surfactants such as those described in Japanese Patent Application Laid-Open No. 62-251740 and Japanese Patent Application Laid-Open No. 3-208514, and amphoteric surfactants such as those described in Japanese Patent Application Laid-Open No. 59-121044 and Japanese Patent Application Laid-Open No. 4-13149.

Specific examples of the nonionic surfactants include sorbitan tristearate, sorbitan monopalmitate, sorbitan trioleate, stearic acid monoglyceride, and polyoxyethlene nonylphenyl ether.

Specific examples of the amphoteric surfactants include alkyldi(aminoethyl)glycine, alkylpolyaminoethylglycine hydrochloric acid, 2-alkyl-N-carboxyethyl-N-hydroxyethylimidazolinium betaine, and an N-tetradecyl-N,N-betaine type surfactant (for example, Amogen K manufactured by Daiichi Kogyo Seiyaku Co., Ltd.).

The proportion of the nonionic surfactants and amphoteric surfactants in the coating liquid for the image-forming layer is preferably 0.05 to 15% by mass, more preferably 0.1 to 5% by mass.

Further, in order to impart flexibility and the like to the film, plasticizers may be added, if necessary, to the coating liquid for the image-forming layer of the present invention. There may be used, for example, polyethyleneglycol, tributyl citrate, diethyl phthalate, dibutyl phthalate, dihexyl phthalate, dioctyl phthalate, tricresyl phosphate, tributyl phosphate, trioctyl phosphate, and tetrahydrofurfuryl oleate.

### 3. Image Forming Layer Containing Hydrophobizable Precursor

As a still another image-forming layer applicable to the support for lithographic printing plate in the present invention, there may be mentioned a thermosensitive image-forming layer containing a compound (hereinafter, referred to as a hydrophobizable precursor as appropriate) which can form hydrophobic regions upon heating or irradiation of radiant rays. This type of image-forming layer comprises a compound, such as in polymer microparticles (a) having heat reactive functional groups or microcapsules (b) encapsulating a compound having heat reactive functional groups, which fuses together by heating or, in case of the microcapsules, for example, the encapsulated material initiates chemical reactions by heat to form an image region, namely, a hydrophobic region (inkphilic region). Preferably, these are dispersed in a hydrophilic binder, so that, after image formation (exposure to light), the lithographic printing plate precursor is mounted on a cylinder of a printing machine, supplied with a wetting water and/or ink, and developed on-press without any particular developing treatment.

This image-forming layer contains polymer microparticles (a) having thermally reactive functional groups or microcapsules (b) encapsulating a compound having thermally reactive functional groups.

The thermally reactive functional groups, common to the above-mentioned (a) and (b), include, for example, ethylenic unsaturated groups which undergo polymerization (for example, an acryloyl group, a methacryloyl group, a vinyl group, and an allyl group); isocyanate groups or blocked groups thereof which undergo addition reactions and their reaction counterparts, i.e., functional groups having active hydrogen atoms (for example, amino, hydroxyl, and carboxylic groups); epoxy groups which undergo similar addition reactions and their reaction counterparts, i.e., amino groups, carboxyl groups, or hydroxyl groups; carboxyl groups which undergo condensation reactions and hydroxyl groups or amino groups; and acid anhydrides which undergo ring opening addition reactions and amino groups or hydroxyl groups. The thermally reactive groups used in the present invention are not limited to these, and, as long as a chemical bond is formed, any functional group may be employed, whatever reaction it may undergo.

[Polymer Microparticles Having Thermally Reactive Functional Groups (a)]

The thermally reactive functional groups suitable for polymer microparticles (a) include, for example, an acryloyl group, a methacryloyl group, a vinyl group, an allyl group, an epoxy group, an amino group, a hydroxyl group, a carboxyl group, an isocyanate group, and an acid anhydride and its blocked groups. Introduction of the thermally reactive functional groups to the polymer microparticles may be carried out during polymerization of the polymer, or after polymerization by use of polymer reactions.

When thermally reactive functional groups are introduced during polymerization, it is preferable to carry out emulsion polymerization or suspension polymerization using monomers having the thermally reactive functional groups.

Specific examples of the monomers having thermally reactive functional groups include allyl methacrylate, allyl acrylate, vinyl methacrylate, vinyl acrylate, glycidyl methacrylate, glycidyl acrylate, 2-isocyanatoethyl methacrylate and block isocyanates thereof with alcohols and the like, 2-isocyanatoethyl acrylate, block isocyanates thereof with alcohols and the like, 2-aminoethyl methacrylate, 2-aminoehtyl acrylate, 2-hydroxyethyl methacrylate, 2-hydroxyethyl acrylate, acrylic acid, methacrylic acid, maleic anhydride, bifunctional acrylate, and bifunctional methacrylate. The monomers having thermally reactive functional groups used in the present invention are not limited to these.

Monomers having no thermally reactive functional group, which can copolymerize with the aforementioned monomers include, for example, styrene, alkyl acrylates, alkyl methacrylates, acrylonitrile, and vinyl acetate. The monomers having no thermally reactive functional group, which are used in the present invention are not limited to these.

Polymer reactions which may be employed to introduce the thermally reactive functional groups to the polymer after polymerization include the polymer reactions described in, for example, WO 96/34316.

Among the aforementioned polymer microparticles (a) having the thermally reactive functional groups, those which fuse and coalesce together easily by heat are preferable from a viewpoint of image-forming property, and those having hydrophilic surfaces and which can disperse in water are especially preferable from a viewpoint of on-press developability. Further, when only polymer microparticles are coated, it is preferable that a contact angle (a water droplet in air) of a film prepared by drying at a temperature lower than the solidification temperature is smaller than the contact angle (a water droplet in air) of a film prepared by drying at a temperature higher than the solidification temperature.

In order to bring the surface hydrophilicity of the polymer microparticles to such a desirable state, hydrophilic polymers or oligomers such as polyvinyl alcohol, polyethylene glycols and the like; or hydrophilic low molecular weight compounds may be adsorbed on the surface of the polymer microparticles. However, the method to hydrophilicize the surface of microparticles are not limited to these and various known surface hydrophilicizing methods may be applied.

Thermal fusion temperatures of the polymer microparticles (a) having thermally reactive functional groups are preferably 70° C. or higher, but when temporal stability is considered, they are more preferably 80° C. or higher. However, too high thermal fusion temperatures are not preferable from a sensitivity viewpoint and, thus, the fusion temperatures are preferably in a range of 80 to 250° C., more preferably in a range of 100 to 150° C.

The average particle size of the polymer microparticles (a) is preferably in a range of 0.01 to 20 μm, more preferably 0.05 to 2.0 μm, most preferably 0.1 to 1.0 μm. In this range, excellent resolution and temporal stability are obtained.

The amount of polymer microparticles (a) to be added is preferably 50 to 98% by mass, more preferably 60 to 95% by mass, based on the total solids of the image-forming layer.

[Microcapsules Encapsulating Compounds Having Thermally Reactive Functional Groups (b)]

The thermally reactive functional groups suitable for the microcapsules (b) include, in addition to those mentioned above as common to both materials (a) and (b), for example, a polymerizable unsaturated group, a hydroxyl group, a carboxyl group, a carboxylate group, an acid anhydride group, an amino group, an epoxy group, an isocyanate group, and a blocked isocyanate group.

Compounds having the polymerizable unsaturated groups are preferably those which have at least one, preferably two or more ethylenic unsaturated bonds such as, for example, an acryloyl group, a methacryloyl group, a vinyl group, and an allyl group. Such compounds are widely known in the industrial field concerned and, these can be used without any limitation in the present invention. These are present, in terms of chemical types, as a monomer; a prepolymer such as dimer, trimer, and oligomer; mixtures thereof; and copolymers thereof.

Specifically, there may be mentioned, for example, unsaturated carboxylic acids (for example, acrylic acid, methacrylic acid, itaconic acid, crotonic acid, isocrotonic acid, and maleic acid), esters thereof, and unsaturated carboxylic acid amide. Among them, esters of unsaturated carboxylic acids with aliphatic polyhydric alcohols and amides of unsaturated carboxylic acids with aliphatic polyfunctional amines are preferable.

Also used suitably are addition reaction products of unsaturated carboxylic acid esters or amides, having nucleophilic substituents such as a hydroxyl group, an amino group, and a mercapto group, with mono- or poly-functional isocyanates or epoxides; and dehydration condensation products thereof with mono- or poly-functional carboxilic acids.

Further, also suitable are addition reaction products of unsaturated carboxylic acid esters or amides, having electrophilic substituent such as isocyanate groups and epoxy groups, with mono- or poly-functional alcohols, amines, and thiols; or substitution reaction products of unsaturated carboxylic acid esters or amides, having groups with leaving property such as halogen groups or tosyloxy groups, with mono- or poly-functional alcohols, amines, or thiols.

Furthermore, other suitable examples include a compound obtained by replacing the unsaturated carboxylic acid described above with unsaturated phosphonic acid or chloromethylstyrene.

Specific examples of these compounds are described in paragraph Nos. [0014] to [0035] of Japanese Patent Application Laid-Open No. 2001-27742, which the present applicant proposed, and a detailed manufacturing method for the microcapsules encapsulating these compounds is described in paragraph Nos. [0036] to [0039] of the same document. These disclosures are applicable to the present invention.

Microcapsule walls used suitably for the microcapsules (b) have three-dimensional crosslinking and have a property to swell with solvents. From this viewpoint, a preferable material for the microcapsule walls include polyurea, polyurethane, polyester, polycarbonate, polyamide, or a mixture of these. Especially, polyurea and polyurethane are preferable. Also, a compound having thermally reactive functional groups may be introduced to the microcapsule walls.

The average particle size of the microcapsules (b) is preferably 0.01 to 20 μm, more preferably 0.05 to 2.0 μm, especially preferably 0.10 to 1.0 μm. With the particle size in this range, excellent resolution and temporal stability are attained.

According to the mechanism of image formation by use of the microcapsules (b) containing the thermally reactive functional groups, the material of the microcapsule, the compound encapsulated therein, and, further, other optional compounds present in the image-forming layer wherein the microcapsules are dispersed, react and form the image region, namely a hydrophobic region (inkphilic region). Such systems include, for example, a type where microcapsules fuse together by heat as described above; a type where a compound which seeps out, during coating, to the microcapsule surface or outside, or a compound which seeped into the microcapsule wall from outside initiate a reaction by heat; a type where the microcapsule material or encapsulated compounds react with the hydrophilic resin added or a low molecular weight compound added; and a type where two or more kinds of microcapsule walls or encapsulated compounds, each having different functional groups which thermally react with each other, are made to react.

Thus, it is preferable but is not indispensable for image formation that the microcapsules fuse and aggregate together by heat.

The amount of microcapsules (b) added to the image-forming layer is, based on the solids, preferably 10 to 60% by mass, more preferably 15 to 40% by mass. With the amount of microcapsules being in this range, the image-forming layer exhibits excellent on-press developability, and, at the same time, good sensitivity and printing endurance.

When microcapsules (b) are added to the image forming layer, there may be added to the microcapsule dispersion medium a solvent in which the encapsulated material is dissolved and the wall material gets swollen. By such a solvent, diffusion of the encapsulated material, having the thermally reactive functional groups out of the microcapsules is facilitated.

Such a solvent can be selected easily from many commercial solvents, depending on the dispersion medium for the microcapsules; and the wall material, its thickness, and the encapsulated material of the microcapsules. For example, in case of water dispersible microcapsules comprising crosslinked polyurea or polyurethane walls, alcohols, ethers, acetals, esters, ketones, polyhydric alcohols, amides, amines, and fatty acids are preferable.

A solvent, which is not soluble in the microcapsule dispersion, but becomes soluble therein if the aforementioned solvents are mixed, may also be used. The amount of solvents added is determined depending on a combination of materials but if the amount is less than a proper amount, the image formation becomes insufficient. If the amount is excessive, stability of the dispersion deteriorates. Usually, the amount is preferably 5 to 95% by mass, more preferably 10 to 90% by mass, especially preferably 15 to 85% by mass, of the coating liquid.

### [Other Components]

In the thermosensitive image-forming layer of the present embodiment, various additives may be used in combination depending on the purpose, in addition to the aforementioned polymer microparticles (a) having thermally reactive functional groups, having the image-forming property or microcapsules (b) containing compounds having thermally reactive functional groups encapsulated therein.

### (Reaction Initiator, Reaction Accelerator)

In the thermosensitive image-forming layer, there may be added, if necessary, compounds which may initiate or accelerate these reactions. The compounds which initiate or accelerate the reactions include, for example, compounds which generate radicals or cations by heat. Examples include lophine dimers, trihalomethyl compounds, peroxides, azo compounds, onium salts including diazonium salts or diphenyliodonium salts, acylphosphines, and imide sulfonates.

These compounds are added preferably in a range of 1 to 20% by mass, more preferably 3 to 10% by mass, based on the solids of the image forming layer. When the amount is in this range, an excellent reaction initiating effect or reaction accelerating effect is obtained without impairing on-press developability.

### (Hydrophilic Resin)

To such a thermosensitive image-forming layer of the present invention, there may be added hydrophilic resins. Addition of the hydrophilic resins not only improves on-press developability but also increases film strength of the thermosensitive image-forming layer itself.

The hydrophilic resins preferably contain hydrophilic groups such as hydroxyl, carboxyl, hydroxyethyl, hydroxypropyl, amino, aminoethyl, aminopropyl, carboxymethyl, and the like.

Specific examples of the hydrophilic resins include gum arabic, casein, gelatin, starch derivatives, carboxymethyl cellulose and its sodium salt, cellulose acetate, sodium alginate, vinyl acetate-maleic acid copolymers, styrene-maleic acid copolymers, polyacrylic acids and their salts, polymethacrylic acids and their salts, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycols, hydroxypropylene polymers, polyvinyl alcohols, hydrolyzed polyvinyl acetate with a rate of hydrolysis of at least 60% by mass, preferably at least 80% by mass, polyvinyl formal, polyvinyl butyral, polyvinyl pyrrolidone, homopolymers and copolymers of acrylamide, homopolymers and polymers of methacrylamide, homopolymers and copolymers of N-methylol acrylamide.

The amount of the hydrophilic resins to be added to the thermosensitive image-forming layer is preferably 5 to 40% by mass, more preferably 10 to 30% by mass, based on the solids of the image-forming layer. In this range, the image-forming layer exhibits good on-press developability and film strength.

In order to form images on this thermoresponsive image-forming layer (thermosensitive image-forming layer) by scanning exposure by infrared laser light and the like, an infrared absorber (A) is included. A preferable amount of addition thereof is, based on total solids of the coating liquid for the image-forming layer is 1 to 30% by mass, more preferably 5 to 25% by mass. With the content of the infrared absorber in this range, an image-forming layer of excellent sensitivity and image-forming property is obtained.

The image-forming layer containing the hydrophobizable precursor is dissolved or dispersed in a solvent together with all necessary components described above to prepare a coating liquid, which is coated on the hydrophilic surface of the aforementioned support. The solid content of the coating liquid is preferably 1 to 50% by mass.

### [Other Lithographic Printing Plate Precursors]

The present invention can also be used for lithographic printing plate precursors recorded by other means than infrared laser exposure. Hereinafter, examples of lithographic printing plate precursors and image-forming layers other than those for infrared laser exposure will be described in detail.

Preferable examples of positive-type image-forming layers include the following positive-type image-forming layers, (a) and (b), which are heretofore known.

(a) A conventional positive-type image-forming layer comprising naphthoquinone diazide and a novolac resin, which has long been in use.

(b) A chemically amplified positive-type image-forming layer comprising a combination of an alkali soluble compound protected by an acid-decomposable group and an acid generator.

The aforementioned (a) and (b) are well known in the art, but they are more suitably used in combination with the following positive-type image-forming layers, (c) to (f).

(c) A laser-responsive positive-type image-forming layer described in Japanese Patent Application Laid-Open No. 10-282672, which provides a lithographic printing plate which does not require a development treatment, comprising a polymer having solfonic acid ester side chains and an infrared absorber,
(d) A laser-responsive positive-type image-forming layer described in EP 652483 and Japanese Patent Application Laid-Open No. 6-502260, which provide a lithographic printing plate which does not require a development treatment, comprising a polymer having carboxylic ester side chains and an acid generator or an infrared absorber.

(e) A laser-responsive positive-type image-forming layer described in Japanese Patent Application Laid-Open No. 11-095421, comprising an alkali soluble compound and a compound which is thermally decomposable and, when not decomposed, substantially lowers the solubility of the alkali soluble compound.

(f) An alkaline developable positive-type image-forming layer which provides an alkaline developable positive-type lithographic printing plate, comprising an infrared absorber, a novolac resin, and a dissolution inhibitor.

On the lithographic printing plate support of the present invention, the components of a coating liquid for a desired layer such as the image-recording coating liquid are dissolved in a solvent and is coated to form an image-forming layer, thus enabling production of a lithographic printing plate precursor. In addition to the image-forming layer, the lithographic printing plate precursor may be provided with a protective layer, a resin intermediate layer, an undercoat layer, a backcoat layer, and the like, depending on the purpose.

The solvents used herein include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethyl formamide, tetramethylurea, N-methylpyrrolidone, dimethylsulfoxide, sulfolane, γ-butyrolactone, toluene, and the like. Also, when a water-soluble image-forming layer is used, water or water-soluble solvents such as alcohols can be mentioned. However, the solvents are not limited to these but can be suitably selected according to the properties of the image-forming layer. These solvents are used singly or as a mixture.

The concentration of the above-described components (all solids including the additives) is preferably 1 to 50% by mass.

The amount (solid) of coating on the support after coating and drying varies according to applications but, with regard to the photosensitive printing plate in general, it is preferably in a range of 0.5 to 5.0 g/m². As the coated amount decreases, the apparent sensitivity increases but the film characteristics of the photosensitive film deteriorates.

As a coating method, various methods can be used. For example, there may be cited bar coater coating, spin coating, spray coating, curtain coating, dip coating, air knife coating, blade coating, and roll coating.

In the lithographic printing plate precursor of the present invention, adhesion between the support and image-forming layer is excellent and the hydrophilic support surface becomes exposed rapidly by development. Thus, anti-staining property of the non-image region is improved and, even under severe printing conditions, a number of printed sheets of high image quality are obtained.

The lithographic printing plate precursor of the present invention may be subjected to heretofore known plate making methods, suitable for the image-forming layer, to obtain a lithographic printing plate.

Thereafter, the lithographic printing plate obtained is mounted on a printing machine and used for printing a number of sheets.

### [Backcoat Layer]

On the backside (the side where the image-forming layer is not formed) of the lithographic printing plate precursor obtained as described above, there may be disposed, according to necessity, a covering layer (hereinafter, also referred to as “a backcoat layer”) comprising organic polymer compounds, in order to protect the image-forming layer from scratches even when piled up. As the main component of the backcoat layer, there may preferably be used at least one kind of resin having a glass transition temperature of 20° C. or higher, selected from a group consisting of a saturated copolymerized polyester resin, phenoxy resin, polyvinyl acetal resin, and vinylidene chloride copolymerized resin.

The saturated copolymerized polyester resin comprises dicarboxylic acid units and diol units. The dicarboxylic acid units include, for example, aromatic dicarboxylic acid such as phthalic acid, terephthalic acid, isophthalic acid, tetrbromophthalic acid, tetrachlorophthalic acid; saturated aliphatic dicarboxylic acids such as adipic acid, azelaic acid, succinic acid, citric acid, suberic acid, sebacic acid, malonic acid, 1,4-cyclohexanedicarboxylic acid. Further, the backcoat layer may suitably comprises dyes and pigments for coloring, silane coupling agents for improving adhesion with the support, a diazo resin comprising diazonium salts, organic phosphonic acids, organic phosphoric acids, cationic polymers, waxes usually used as a slipping agent, higher fatty acids, higher fatty acid amides, silicone compounds comprising dimethylsiloxane, modified dimethylsiloxane, polyethylene powder, and the like.

The thickness of the backcoat layer is basically such that, without an inserting paper, the backside does not leave scratches on the image-forming layer too easily, and is preferably 0.01 to 8 μm. If the thickness is less than 0.01 μm, it is difficult to prevent scratches left on the image-forming layer when the lithographic printing plates are handled in piles. Also, when the thickness exceeds 8 μm, the thickness of the backcoat layer may vary because of its swelling with chemicals used during printing in the vicinity of the lithographic printing plate, resulting in variation of a printing pressure, which may sometimes cause deterioration of printing characteristics.

There may be used various methods for forming the backcoat layer on the backside of the lithographic printing plate precursors. These include, for example, a method to coat a solution of the backcoat layer components dissolved in a suitable solvent or an emulsion/dispersion thereof, followed by drying; a method to bond a film, prepared from the backcoat layer compounds beforehand, onto the image-forming film precursor by means of an adhesive or heat; a method to form a molten film out of a melt extruder, which is adhered to the image-forming layer precursor. The most preferable method for securing an adequate thickness is the method whereby the backcoat layer components are dissolved in a suitable solvent and the solution is coated and dried.

In manufacturing the lithographic printing plate precursors, either of the backcoat layer on the backside or the image-forming layer on the surface may be disposed first on the support, or both may be disposed at the same time. The lithographic printing plate precursors thus obtained are, according to necessity, cut into appropriate sizes, exposed to light, developed, and made into the lithographic printing plates. In case of a lithographic printing plate precursor provided with a visible light exposure type plate-making layer (photosensitive plate-making layer), a transparent film on which the printing image is formed is overlaid thereon, exposed by irradiation of usual visible light, and thereafter developed to make plates. In case of a lithographic printing plate precursor provided with a laser exposure type plate-making layer, the plate is exposed by writing the printing image directly with irradiation of various laser light, and thereafter developed to make the plates.

As heretofore described, by employing the method for drying the coated film according to the present invention, there can be suppressed occurrence of defects in appearance and failure in performance on the product surface. Thus far, as one of the examples of the method for drying the coated film according to the present invention, the method for drying a lithographic printing plate precursor has been described, but the present invention is not limited to the embodiments described above. For example, the present invention can be applied to other drying steps in the manufacturing process of the lithographic printing plate precursors. Also, the present invention is not limited to the manufacturing field of the lithographic printing plate precursors but may be applied to the manufacturing processes in various technical fields such as, for example, electrode materials, functional films, and optical films.

### EXAMPLES

### (Test 1)

As the support, aluminum (width, 1300 mm; thickness, 0.24 mm) was used, which was conveyed at a line speed of 60 m/min. On this support, a coating liquid was coated by a bar coating method and, after drying by hot air, there was carried out drying using a drier of the present invention. The drying apparatus used was one which had a clearance of 20 mm between the nozzle tip and the web.

As the coating liquid, a polymer solution in organic solvent was used. This polymer solution in an organic solvent contained, as the solvent used, methyl ethyl ketone (70%) and γ-butyrolactone (30%) and, as the polymer, an acrylic type resin. In this polymer solution in an organic solvent, γ-butyrolactone corresponds to the first solvent.

Drying by hot air was carried out using hot air of 140° C., 10 g/m³, and 20,000 m³/h. The zone length was 30 m.

In the drying apparatus (vapor atmosphere drying section) of the present invention, steam-containing hot air containing water (steam) as the second solvent was blown onto the support. As the condition of drying, the steam-containing hot air was set at; 140° C., 300 g-H₂O/m³, and 200 kg-H₂O/h. Also, the configuration of the box of the vapor atmosphere drying section was: length in the width direction, W=2,000 mm; length in the longitudinal direction, L=800 mm; W/L=2.5.

Further, as the vapor atmosphere drying section, in Example 1 was used one with a configuration illustrated in FIG. 4 and in Example 2 was used one with a configuration shown in FIG. 7 (the support roller was a metal roller of φ75 mm). Furthermore, in Comparative Example 1, a drying section with a configuration illustrated in FIG. 6 was used.

In the tests of Examples 1, 2, and Comparative Example 1, the coating liquid was coated on the aluminum web by a coating machine and, thereafter, the web was conveyed through a hot air drying section using dry air and dried for 30 seconds. As a result, the coated film reaches a drying point and solidifies. This is thereafter conveyed continuously to the vapor atmosphere drying sections of Examples 1, 2, and Comparative Example 1, and was dried under a steam atmosphere for 0.8 second. Thereafter, a piece was cut out from the wound web and the amount of residual γ-butyrolactone (γ-BL) remaining in the film was measured by gas chromatography at seven points in the width direction to examine residual distribution in the width direction. The results of measurement are shown in Table 1. In Table 1, the positions on the aluminum web are shown with the center of the web set as the standard (0 mm), and a position right to this is denoted by a plus sign and the left side by a minus sign. Further, the “Reference” in Table 1 shows results of measurement of the web immediately prior to the vapor atmosphere drying section.

TABLE 1
Amount of residual solvent in width direction

| | Amount of residual γ-BL at respective positions on | | | | | | | Average amount of | |
|---|---|---|---|---|---|---|---|---|---|
| | aluminum web [mg/m²] | | | | | | | residual solvent | Standard |
| | −600 mm | −400 mm | −200 mm | 0 mm | 200 mm | 400 mm | 600 mm | [mg/m²] | deviation |
| Reference | 80.5 | 96.5 | 97.9 | 102.8 | 95.0 | 83.5 | 80.9 | 91.0 | 9.14 |
| Comparative | 59.4 | 50.3 | 34.7 | 30.2 | 30.3 | 41.0 | 58.5 | 43.5 | 12.6 |
| Example 1-1 | | | | | | | | | |
| Example 1-1 | 41.9 | 36.2 | 33.8 | 30.3 | 34.6 | 37.0 | 42.1 | 36.6 | 4.29 |
| Example 1- | 29.6 | 30.5 | 29.5 | 29.6 | 30.6 | 29.0 | 30.3 | 29.9 | 0.60 |

As can be seen from Table 1, Comparative Example 1-1 shows formation of an uneven distribution of the residual first solvent in the width direction. In contrast, in Example 1-1 where the windshield plates and, on both sides thereof, the exhaust outlets are disposed, uneven distribution of the residual first solvent was greatly decreased. Also, in Example 1-2 where a support roller was installed, uneven distribution of the residual first solvent was further decreased.

### (Test 2)

In Examples 2-1 and 2-2, tests were carried out by the same method as in Example 1, except that the gap S between the windshield plates and the support was changed. The results are shown in Table 2. In addition, Comparative Example 2-1 and Example 2-3 in Table 2 show the same data as Comparative Example 1-1 and Example 1-1 in Test 1, respectively.

TABLE 2

| | Windshield plates | Gap S [mm] | Standard deviation |
|---|---|---|---|
| Comparative | None | — | 12.6 |
| Example 2-1 | | | |
| Example 2-1 | Present | 20 | 12.2 |
| Example 2-2 | Present | 10 | 5.71 |
| Example 2-3 | Present | 3 | 4.29 |

As can be seen from Table 2, when the gap S is 10 mm or less, uneven distribution of the residual first solvent becomes small. When the gap S was 3 mm or less, uneven distribution of the residual first solvent could be made even smaller. Because the clearance between the tip of the nozzle and the web is 20 mm, it can be seen that the gap S is preferably ½ or less, more preferably ¼ or less, relative to this clearance.

### (Test 3)

Examples 3-1 to 3-8 were carried out using the apparatus shown in FIG. 7 by the same method as in Test 1, except that the condition of the steam-containing hot air was changed. Further, Comparative Example 3-1 was conducted using the apparatus illustrated in FIG. 6. In addition, the saturated amount of steam of water at 100° C. under ordinary pressure is about 600 g/m³. The results are shown in Table 3.

TABLE 3

| | Condition of | | |
|---|---|---|---|
| | steam-containing hot air | | |
| | Steam | Amount of | |
| | temperature | steam | Average amount of |
| | [° C.] | [g/m³] | residual γ-BL [mg/m²] |
| Reference | — | — | 102.8 |
| Comparative | 140 | — | 85.9 |
| Example 3-1 | | | |
| Example 3-1 | 140 | 550 | 19.6 |
| Example 3-2 | 140 | 300 | 30.3 |
| Example 3-3 | 140 | 120 | 70.6 |
| Example 3-4 | 140 | 100 | 86.1 |
| Example 3-5 | 120 | 300 | 41.8 |
| Example 3-6 | 100 | 300 | 50.1 |
| Example 3-7 | 90 | 300 | 77.2 |
| Example 3-8 | 80 | 300 | 98.7 |

As can be seen from Table 3, the amount of the residual solvent decreases as the amount of steam increases. Especially, in Examples 3-1 to 3-3 where the amount of steam corresponds to 0.2 to 1.0 times the saturated amount of steam, the residual amount could be decreased. Also, in Examples 3-7 and 3-8 where the steam temperature is lower than the boiling point, the residual amount increased; in Examples 3-5 and 3-6 where the steam temperature is higher than the boiling point, the residual amount could be decreased.

### (Test 4)

In order to show the effect of drying using the drier of the present invention at W/L≧1, tests were carried out by the same method as in Test 1, using the traditional apparatus illustrated in FIG. 6.

TABLE 4

| | Width | Distance | | Width of | | |
|---|---|---|---|---|---|---|
| | W | L | | aluminum used | Standard | |
| | [mm] | [mm] | W/L′ | [mm] | deviation | Judgment |
| Test Example 4-1 | 400 | 800 | 0.5 | 300 | 0.569 | OK |
| Test Example 4-2 | 600 | 800 | 0.75 | 450 | 2.82 | OK |
| Test Example 4-3 | 800 | 800 | 1 | 600 | 4.65 | NG |
| Test Example 4-4 | 1600 | 800 | 2 | 1000 | 8.31 | NG |
| Test Example 4-5 | 2000 | 800 | 2.5 | 1300 | 12.6 | NG |

As is clear from Table 4, uneven drying cannot be avoided by the traditional drying method, as shown by Test Examples 4-3 to 4-5 where W/L≧1. In contrast, the present invention enables prevention of occurrence of uneven drying even in the range of W/L≧1 as shown in Test 1.

Further, similar results were obtained with the infrared laser recording lithographic printing plates, polymerization curing negative-type lithographic printing plates, and other lithographic printing plate precursors.

What is claimed is:

1. A method for drying a material to be dried, the material containing a first solvent and being conveyed, comprising the steps of:
supplying hot air from a supply unit to the material, the hot air containing vapor of a second solvent having a smaller or equal molecular volume than the molecular volume of the first solvent,
wherein exhaust is discharged at farther upstream and farther downstream portions from windshield plates disposed at upstream and downstream of the supply unit, in the direction of conveying the material to be dried.

2. The method for drying according to claim 1, wherein the material to be dried is supported by a support roller from an opposite side of the supply unit.

3. The method for drying according to claim 1, wherein, when the distance between the windshield plates and width of the vapor-containing hot air supply unit are denoted by L and W, respectively, a relationship W/L≧1 is satisfied.

4. The method for drying according to claim 2, wherein, when the distance between the windshield plates and width of the vapor-containing hot air supply unit are denoted by L and W, respectively, a relationship W/L≧1 is satisfied.

5. The method for drying according to claim 1, wherein the ratio of the amount of vapor of the second solvent is 0.2 or more but 1.0 or less to the saturated vapor amount of the second solvent at the boiling point under ordinary pressure.

6. The method for drying according to claim 2, wherein the ratio of the amount of vapor of the second solvent is 0.2 or more but 1.0 or less to the saturated vapor amount of the second solvent at the boiling point under ordinary pressure.

7. The method for drying according to claim 3, wherein the ratio of the amount of vapor of the second solvent is 0.2 or more but 1.0 or less to the saturated vapor amount of the second solvent at the boiling point under ordinary pressure.

8. The method for drying according to claim 4, wherein the ratio of the amount of vapor of the second solvent is 0.2 or more but 1.0 or less to the saturated vapor amount of the second solvent at the boiling point under ordinary pressure.

9. The method for drying according to claim 1, wherein the temperature of hot air containing the vapor of the second solvent is not lower than the boiling point of the second solvent under ordinary pressure.

10. The method for drying according to claim 2, wherein the temperature of hot air containing the vapor of the second solvent is not lower than the boiling point of the second solvent under ordinary pressure.

11. The method for drying according to claim 3, wherein the temperature of hot air containing the vapor of the second solvent is not lower than the boiling point of the second solvent under ordinary pressure.

12. The method for drying according to claim 4, wherein the temperature of hot air containing the vapor of the second solvent is not lower than the boiling point of the second solvent under ordinary pressure.

13. The method for drying according to claim 5, wherein the temperature of hot air containing the vapor of the second solvent is not lower than the boiling point of the second solvent under ordinary pressure.

14. The method for drying according to claim 6, wherein the temperature of hot air containing the vapor of the second solvent is not lower than the boiling point of the second solvent under ordinary pressure.

15. The method for drying according to claim 7, wherein the temperature of hot air containing the vapor of the second solvent is not lower than the boiling point of the second solvent under ordinary pressure.

16. The method for drying according to claim 8, wherein the temperature of hot air containing the vapor of the second solvent is not lower than the boiling point of the second solvent under ordinary pressure.

17. A drying apparatus, comprising:
a supply unit which supplies hot air containing vapor of a second solvent having a smaller or equal molecular volume than the molecular volume of a first solvent to a material to be dried, the material containing the first solvent and being conveyed,
exhaust outlets disposed at upstream and downstream of the supply unit in relation to the direction of conveying the material to be dried; and
windshield plates disposed between the exhaust outlets and the supply unit and with a predetermined gap from the material to be dried.

18. The drying apparatus according to claim 17, wherein a support roller is installed at the opposite side of the material to be dried from the supply unit and the support roller is made to come in contact with the material to be dried.

19. The drying apparatus according to claim 17, wherein, when the distance between the windshield plates themselves and width of the supply unit are denoted by L and W, respectively, a relationship W/L≧1 l is satisfied.

20. The drying apparatus according to claim 18, wherein, when the distance between the windshield plates themselves and width of the supply unit are denoted by L and W, respectively, a relationship W/L≧1 is satisfied.
